(19) United States
(12) Patent Application Publication
(10) Pub. No.: US 2023/0066819 A1
(43) Pub. Date: Mar. 2, 2023

(54) VEHICLE DRIVING ASSISTANCE APPARATUS, VEHICLE DRIVING ASSISTANCE METHOD, AND VEHICLE CONTROL APPARATUS

(71) Applicant: Mitsubishi Electric Corporation, Tokyo (JP)

(72) Inventors: Kazuhiro NISHIWAKI, Tokyo (JP); Tomoki UNO, Tokyo (JP)

(73) Assignee: Mitsubishi Electric Corporation, Tokyo (JP)

(21) Appl. No.: 17/859,525

(22) Filed: Jul. 7, 2022

(30) Foreign Application Priority Data
Aug. 30, 2021 (JP) 2021-140162

(51) Int. Cl. B60W 30/16; B60W 10/04; B60W 10/18

(52) U.S. Cl. CPC B60W 30/16; B60W 10/04; B60W 10/18; B60W 2554/802; B60W 2554/4041; B60W 2520/10; B60W 2554/804; B60W 2720/10; B60W 2754/30; B60W 2720/106

(57) ABSTRACT

A plan creating unit calculates a target inter-vehicle distance from relative speed information indicating relative speed of a preceding vehicle and host vehicle speed information indicating speed of a host vehicle, and creates, using an inter-vehicle distance between the host vehicle and the preceding vehicle indicated by distance information and the target inter-vehicle distance, a distance plan indicating changes over time of the inter-vehicle distance, a speed plan indicating changes over time of the speed of the host vehicle, and an acceleration plan indicating changes over time of acceleration of the host vehicle. A vehicle control unit calculates an acceleration control signal for controlling the acceleration of the host vehicle, using the distance information, the distance plan, the host vehicle speed information, and the speed plan. An instruction integrating unit generates an acceleration instruction using the acceleration control signal and the acceleration plan.

### TECHNICAL FIELD

The present disclosure relates to a vehicle driving assistance apparatus, a vehicle driving assistance method, and a vehicle control apparatus.

### BACKGROUND ART

There is a vehicle control apparatus that controls the speed of a host vehicle so that the host vehicle follows a preceding vehicle (see Patent Literature 1). The preceding vehicle is a vehicle traveling ahead of the host vehicle. The vehicle control apparatus includes a calculating unit and a travel control unit. The calculating unit sequentially calculates target speed of the host vehicle on the basis of an inter-vehicle distance between the host vehicle and the preceding vehicle and the speed of the preceding vehicle. The travel control unit sequentially controls a driving apparatus of the host vehicle or a braking apparatus of the host vehicle on the basis of the target speed calculated by the calculating unit.

### CITATION LIST

### Patent Literature

Patent Literature 1: JP 2017-081426 A

### SUMMARY OF INVENTION

### Technical Problem

In the vehicle control apparatus disclosed in Patent Literature 1, during a period during which the host vehicle is following the preceding vehicle, if a control response of the travel control unit is slow, then a dangerous situation may occur in which the host vehicle gets too close to the preceding vehicle and collides with the preceding vehicle. On the other hand, if a control response of the travel control unit is fast, then there is a problem of occurrence of fluctuations in speed such as repetition of an increase and a decrease in the speed of the host vehicle.

The present disclosure is made to solve problems such as those described above, and an object of the present disclosure is to obtain a vehicle driving assistance apparatus and a vehicle driving assistance method that can prevent each of occurrence of a situation in which the host vehicle gets too close to the preceding vehicle and occurrence of a situation of fluctuations in the speed of the host vehicle, during a period during which the host vehicle is following the preceding vehicle.

### Solution to Problem

A vehicle driving assistance apparatus according to the present disclosure includes: information obtaining circuitry to obtain, from a first vehicle detection sensor to detect a preceding vehicle that is a vehicle traveling ahead of a host vehicle, distance information indicating an inter-vehicle distance between the host vehicle and the preceding vehicle and relative speed information indicating relative speed of the preceding vehicle with respect to the host vehicle, and obtain host vehicle speed information indicating speed of the host vehicle from a speed sensor; plan creating circuitry to calculate a target inter-vehicle distance from the relative speed information and the host vehicle speed information, and create, using the inter-vehicle distance indicated by the distance information and the target inter-vehicle distance, a distance plan indicating changes over time of the inter-vehicle distance, a speed plan indicating changes over time of the speed of the host vehicle, and an acceleration plan indicating changes over time of acceleration of the host vehicle, for a period during which the host vehicle is following the preceding vehicle, the target inter-vehicle distance being a target value of the inter-vehicle distance between the host vehicle and the preceding vehicle; vehicle control circuitry to calculate an acceleration control signal for controlling the acceleration of the host vehicle, using the distance information, the distance plan, the host vehicle speed information, and the speed plan; and instruction integrating circuitry to generate an acceleration instruction using the acceleration control signal calculated by the vehicle control circuitry and the acceleration plan, the acceleration instruction being to be provided to a driving and braking control apparatus of the host vehicle.

### Advantageous Effects of Invention

According to the present disclosure, each of occurrence of a situation in which the host vehicle gets too close to the preceding vehicle and occurrence of a situation of fluctuations in the speed of the host vehicle can be prevented during a period during which the host vehicle is following the preceding vehicle.

### BRIEF DESCRIPTION OF DRAWINGS

FIG. 1 is an explanatory diagram showing a host vehicle VH on which a vehicle driving assistance apparatus 3 according to a first embodiment is mounted, and a preceding vehicle VL.

FIG. 2 is a configuration diagram showing a vehicle control apparatus including the vehicle driving assistance apparatus 3 according to the first embodiment.

FIG. 3 is a hardware configuration diagram showing hardware of the vehicle driving assistance apparatus 3 according to the first embodiment.

FIG. 4 is a hardware configuration diagram of a computer at a time when the vehicle driving assistance apparatus 3 is implemented by software, firmware, or the like.

FIG. 5 is a flowchart showing a vehicle driving assistance method which is a processing procedure performed in the vehicle driving assistance apparatus 3.

FIGS. 6A-6C are explanatory diagrams showing an exemplary operation of a vehicle control apparatus disclosed in Patent Literature 1, and FIG. 6A shows changes over time of an inter-vehicle distance d between a host vehicle VH and a preceding vehicle VL, FIG. 6B shows changes over time of speed v of the host vehicle VH, and FIG. 6C shows changes over time of acceleration a of the host vehicle VH.

FIG. 7A is an explanatory diagram showing a distance plan dₚₗₐₙ, FIG. 7B is an explanatory diagram showing a speed plan vₚₗₐₙ, and FIG. 7C is an explanatory diagram showing an acceleration plan aₚₗₐₙ.

FIG. 8A is an explanatory diagram showing a distance plan dₚₗₐₙ, FIG. 8B is an explanatory diagram showing a speed plan vₚₗₐₙ, and FIG. 8C is an explanatory diagram showing an acceleration plan aₚₗₐₙ.

FIG. 9A is an explanatory diagram showing a distance plan dₚₗₐₙ, FIG. 9B is an explanatory diagram showing a speed plan vₚₗₐₙ, and FIG. 9C is an explanatory diagram showing an acceleration plan aₚₗₐₙ.

FIG. 10 is a configuration diagram showing a vehicle control apparatus including a vehicle driving assistance apparatus 3 according to a second embodiment.

FIG. 11 is a hardware configuration diagram showing hardware of the vehicle driving assistance apparatus 3 according to the second embodiment.

FIG. 12 is an explanatory diagram showing a host vehicle VH on which a vehicle driving assistance apparatus 3 according to a third embodiment is mounted, and a side vehicle VS traveling in a lane to which the host vehicle VH makes a lane change.

FIG. 13 is a configuration diagram showing a vehicle control apparatus including the vehicle driving assistance apparatus 3 according to the third embodiment.

FIG. 14 is a hardware configuration diagram showing hardware of the vehicle driving assistance apparatus 3 according to the third embodiment.

FIG. 15 is an explanatory diagram showing a neighborhood map including the location of the host vehicle VH.

FIG. 16 is an explanatory diagram showing a path for the host vehicle VH to reach a main lane L1 from a merging lane L2.

FIG. 17 is a configuration diagram showing a vehicle control apparatus including a vehicle driving assistance apparatus 3 according to a fourth embodiment.

FIG. 18 is a hardware configuration diagram showing hardware of the vehicle driving assistance apparatus 3 according to the fourth embodiment.

FIG. 19 is an explanatory diagram showing the host vehicle VH, the side vehicle VS, and a roadside apparatus RSU.

FIG. 20 is a configuration diagram showing a vehicle control apparatus including a vehicle driving assistance apparatus 3 according to a fifth embodiment.

### DESCRIPTION OF EMBODIMENTS

To describe the present disclosure in more detail, embodiments for carrying out the present disclosure will be described below with reference to the accompanying drawings.

### First Embodiment

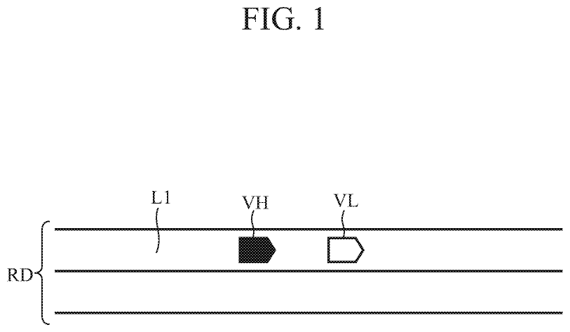

FIG. 1 is an explanatory diagram showing a host vehicle VH on which a vehicle driving assistance apparatus 3 according to a first embodiment is mounted, and a preceding vehicle VL.

The host vehicle VH is traveling in a lane L1 on the left side of a road RD. The preceding vehicle VL is a vehicle traveling ahead of the host vehicle VH. When there are a plurality of vehicles traveling ahead in the same lane L1 as the host vehicle VH, of the plurality of vehicles, a vehicle with the shortest distance from the host vehicle VH is the preceding vehicle VL.

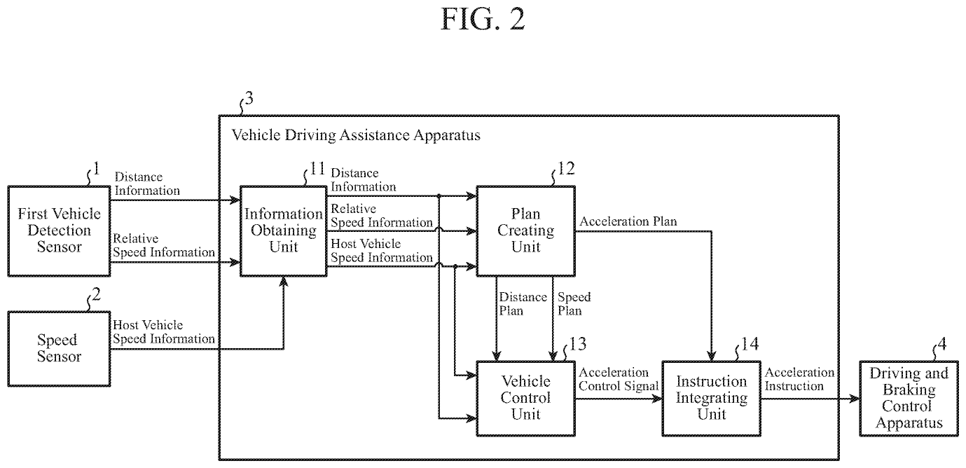

FIG. 2 is a configuration diagram showing a vehicle control apparatus including the vehicle driving assistance apparatus 3 according to the first embodiment.

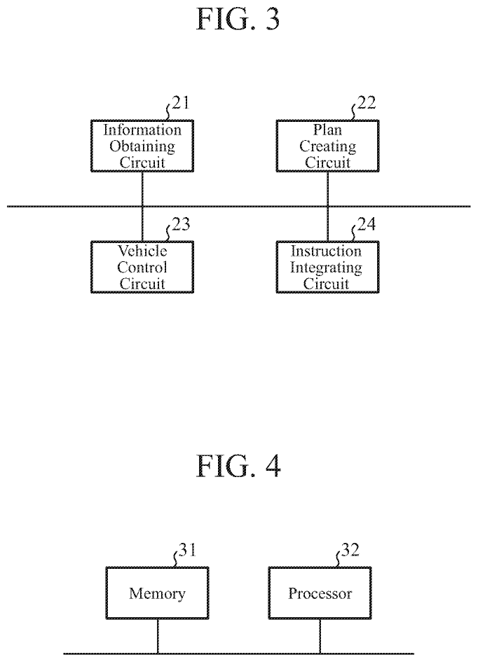

FIG. 3 is a hardware configuration diagram showing hardware of the vehicle driving assistance apparatus 3 according to the first embodiment.

The vehicle control apparatus shown in FIG. 2 includes a first vehicle detection sensor 1, a speed sensor 2, the vehicle driving assistance apparatus 3, and a driving and braking control apparatus 4. The vehicle control apparatus shown in FIG. 2 is installed in the host vehicle VH.

The first vehicle detection sensor 1 detects the preceding vehicle VL.

The first vehicle detection sensor 1 calculates each of an inter-vehicle distance d between the host vehicle VH and the preceding vehicle VL and relative speed vᵣₑₗ of the preceding vehicle VL with respect to the host vehicle VH.

The first vehicle detection sensor 1 outputs distance information indicating the inter-vehicle distance d and relative speed information indicating the relative speed vᵣₑₗ of the preceding vehicle VL to the vehicle driving assistance apparatus 3.

In the vehicle control apparatus shown in FIG. 2, the first vehicle detection sensor 1 calculates each of the inter-vehicle distance d and the relative speed vᵣₑₗ of the preceding vehicle VL. However, this is merely an example, and the vehicle control apparatus may include a sensor that can calculate the inter-vehicle distance d and a sensor that can calculate the relative speed vᵣₑₗ of the preceding vehicle VL, instead of the first vehicle detection sensor 1.

The speed sensor 2 detects speed v of the host vehicle VH and outputs host vehicle speed information indicating the speed v of the host vehicle VH to the vehicle driving assistance apparatus 3.

The vehicle driving assistance apparatus 3 generates an acceleration instruction a_{ref} which is to be provided to the driving and braking control apparatus 4 of the host vehicle VH, so that the host vehicle VH travels following the preceding vehicle VL.

The driving and braking control apparatus 4 controls a driving apparatus (not shown) of the host vehicle VH or a braking apparatus (not shown) of the host vehicle VH on the basis of the acceleration instruction a_{ref} outputted from the vehicle driving assistance apparatus 3.

The vehicle driving assistance apparatus 3 includes an information obtaining unit 11, a plan creating unit 12, a vehicle control unit 13, and an instruction integrating unit 14.

The information obtaining unit 11 is implemented by, for example, an information obtaining circuit 21 shown in FIG. 3.

The information obtaining unit 11 obtains the distance information indicating the inter-vehicle distance d and the relative speed information indicating the relative speed vᵣₑₗ of the preceding vehicle VL from the first vehicle detection sensor 1.

In addition, the information obtaining unit 11 obtains the host vehicle speed information indicating the speed v of the host vehicle VH from the speed sensor 2.

The information obtaining unit 11 outputs the distance information to each of the plan creating unit 12 and the vehicle control unit 13, and outputs the relative speed information to the plan creating unit 12. In addition, the information obtaining unit 11 outputs the host vehicle speed information to each of the plan creating unit 12 and the vehicle control unit 13.

The plan creating unit 12 is implemented by, for example, a plan creating circuit 22 shown in FIG. 3.

The plan creating unit 12 obtains each of the distance information, the relative speed information, and the host vehicle speed information from the information obtaining unit 11.

The plan creating unit 12 calculates a target inter-vehicle distance d* which is a target value of the inter-vehicle distance d between the host vehicle VH and the preceding vehicle VL, from the relative speed information and the host vehicle speed information.

Using the inter-vehicle distance d indicated by the distance information and the target inter-vehicle distance d*, the plan creating unit 12 creates a distance plan dₚₗₐₙ indicating changes over time of the inter-vehicle distance, a speed plan vₚₗₐₙ indicating changes over time of the speed of the host vehicle VH, and an acceleration plan aₚₗₐₙ indicating changes over time of the acceleration of the host vehicle VH, for a period during which the host vehicle VH is following the preceding vehicle VL.

The plan creating unit 12 outputs each of the distance plan dₚₗₐₙ and the speed plan vₚₗₐₙ to the vehicle control unit 13, and outputs the acceleration plan aₚₗₐₙ to the instruction integrating unit 14.

The vehicle control unit 13 is implemented by, for example, a vehicle control circuit 23 shown in FIG. 3.

The vehicle control unit 13 obtains each of the distance information and the host vehicle speed information from the information obtaining unit 11.

In addition, the vehicle control unit 13 obtains each of the distance plan dₚₗₐₙ and the speed plan vₚₗₐₙ from the plan creating unit 12.

The vehicle control unit 13 calculates an acceleration control signal a_{ctrl} for controlling acceleration a of the host vehicle VH, using the distance information, the distance plan dₚₗₐₙ, the host vehicle speed information, and the speed plan vₚₗₐₙ.

The vehicle control unit 13 outputs the acceleration control signal a_{ctrl} to the instruction integrating unit 14.

The instruction integrating unit 14 is implemented by, for example, an instruction integrating circuit 24 shown in FIG. 3.

The instruction integrating unit 14 obtains the acceleration plan aₚₗₐₙ from the plan creating unit 12 and obtains the acceleration control signal a_{ctrl} from the vehicle control unit 13.

The instruction integrating unit 14 generates an acceleration instruction a_{ref} which is to be provided to the driving and braking control apparatus 4 of the host vehicle VH, using the acceleration control signal a_{ctrl} and the acceleration plan aₚₗₐₙ.

The instruction integrating unit 14 outputs the acceleration instruction a_{ref} to the driving and braking control apparatus 4.

In FIG. 2, it is assumed that each of the information obtaining unit 11, the plan creating unit 12, the vehicle control unit 13, and the instruction integrating unit 14 which are the components of the vehicle driving assistance apparatus 3 is implemented by dedicated hardware such as that shown in FIG. 3. Namely, it is assumed that the vehicle driving assistance apparatus 3 is implemented by the information obtaining circuit 21, the plan creating circuit 22, the vehicle control circuit 23, and the instruction integrating circuit 24.

Each of the information obtaining circuit 21, the plan creating circuit 22, the vehicle control circuit 23, and the instruction integrating circuit 24 corresponds, for example, to a single circuit, a combined circuit, a programmed processor, a parallel programmed processor, an application specific integrated circuit (ASIC), a field-programmable gate array (FPGA), or a combination thereof.

The components of the vehicle driving assistance apparatus 3 are not limited to being implemented by dedicated hardware, and the vehicle driving assistance apparatus 3 may be implemented by software, firmware, or a combination of software and firmware.

The software or firmware is stored as a program in a memory of a computer. The computer refers to hardware that executes the program, and corresponds, for example, to a central processing unit (CPU), a central processor, a processing unit, an arithmetic unit, a microprocessor, a microcomputer, a processor, or a digital signal processor (DSP).

FIG. 4 is a hardware configuration diagram of a computer at a time when the vehicle driving assistance apparatus 3 is implemented by software, firmware, or the like.

When the vehicle driving assistance apparatus 3 is implemented by software, firmware, or the like, a program for causing a computer to perform processing procedures performed in the information obtaining unit 11, the plan creating unit 12, the vehicle control unit 13, and the instruction integrating unit 14 is stored in a memory 31. Then, a processor 32 of the computer executes the program stored in the memory 31.

In addition, FIG. 3 shows an example in which each of the components of the vehicle driving assistance apparatus 3 is implemented by dedicated hardware, and FIG. 4 shows an example in which the vehicle driving assistance apparatus 3 is implemented by software, firmware, or the like. However, they are merely examples, and some of the components of the vehicle driving assistance apparatus 3 may be implemented by dedicated hardware and the other components may be implemented by software, firmware, or the like.

Next, operations of the vehicle control apparatus shown in FIG. 2 will be described.

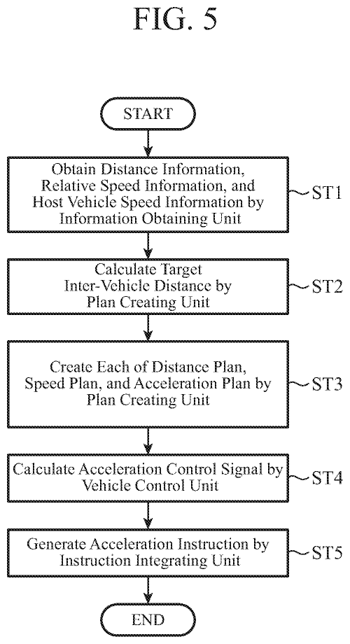

FIG. 5 is a flowchart showing a vehicle driving assistance method which is a processing procedure performed in the vehicle driving assistance apparatus 3.

During a period during which the host vehicle VH is following the preceding vehicle VL, the first vehicle detection sensor 1 performs a process of detecting the preceding vehicle VL.

Then, the first vehicle detection sensor 1 calculates each of an inter-vehicle distance d between the host vehicle VH and the preceding vehicle VL and relative speed vᵣₑₗ of the preceding vehicle VL with respect to the host vehicle VH.

The first vehicle detection sensor 1 outputs distance information indicating the inter-vehicle distance d and relative speed information indicating the relative speed vᵣₑₗ of the preceding vehicle VL to the information obtaining unit 11 in the vehicle driving assistance apparatus 3.

The speed sensor 2 detects speed v of the host vehicle VH and outputs host vehicle speed information indicating the speed v of the host vehicle VH to the information obtaining unit 11.

Here, a process of calculating each of the inter-vehicle distance d and the relative speed vᵣₑₗ by the first vehicle detection sensor 1 will be specifically described.

The first vehicle detection sensor 1, for example, emits radar light ahead of the host vehicle VH and receives reflected light which is the radar light reflected by the preceding vehicle VL.

The first vehicle detection sensor 1 measures time T from the radiation of the radar light to the reception of the reflected light, and multiplies the time T by the speed of light c of the radar light, thereby calculating an inter-vehicle distance d between the host vehicle VH and the preceding vehicle VL.

The first vehicle detection sensor 1 calculates Doppler frequency f_{dop} included in the reflected light, and calculates relative speed vᵣₑₗ of the preceding vehicle VL from the Doppler frequency f_{dop}.

In the vehicle control apparatus shown in FIG. 2, the first vehicle detection sensor 1 calculates each of the inter-vehicle distance d and the relative speed vᵣₑₗ. However, this is merely an example and, for example, the first vehicle detection sensor 1 may only emit radar light and receive reflected light, and the information obtaining unit 11 in the vehicle driving assistance apparatus 3 may calculate each of the inter-vehicle distance d and the relative speed vᵣₑₗ on the basis of the radar light emitted by the first vehicle detection sensor 1 and the reflected light received by the first vehicle detection sensor 1.

The information obtaining unit 11 obtains each of the distance information and the relative speed information from the first vehicle detection sensor 1, and obtains the host vehicle speed information from the speed sensor 2 (step ST1 of FIG. 5).

The information obtaining unit 11 outputs the distance information to each of the plan creating unit 12 and the vehicle control unit 13, and outputs the relative speed information to the plan creating unit 12. In addition, the information obtaining unit 11 outputs the host vehicle speed information to each of the plan creating unit 12 and the vehicle control unit 13.

The plan creating unit 12 obtains each of the distance information, the relative speed information, and the host vehicle speed information from the information obtaining unit 11.

The plan creating unit 12 calculates, as shown in the following expression (1), speed v_{lead} of the preceding vehicle VL from the relative speed vᵣₑₗ of the preceding vehicle VL indicated by the relative speed information and the speed v of the host vehicle VH indicated by the host vehicle speed information.

v_{lead}=vᵣₑₗ+v (1)

Then, the plan creating unit 12 calculates, as shown in the following expression (2), a target inter-vehicle distance d* which is a target value of the inter-vehicle distance d between the host vehicle VH and the preceding vehicle VL, on the basis of the speed v_{lead} of the preceding vehicle VL (step ST2 of FIG. 5).

d*=T_{hw}v_{lead}+Dₛₜₒₚ (2)

In expression (2), T_{hw} is an inter-vehicle time and Dₛₜₒₚ is a target inter-vehicle distance between the host vehicle VH and the preceding vehicle VL when the preceding vehicle VL stops (hereinafter, referred to as “stop distance”).

In the vehicle control apparatus shown in FIG. 2, a plurality of inter-vehicle times are prepared. For example, by a driver of the host vehicle VH operating a switch mounted on the vehicle, any one of the inter-vehicle times can be selected. For the inter-vehicle time, for example, 1 second, 1.5 seconds, or 2 seconds is used.

The stop distance Dₛₜₒₚ may be stored in an internal memory of the plan creating unit 12 or may be provided from a source external to the vehicle control apparatus. In addition, the stop distance Dₛₜₒₚ may be able to be set by the driver of the host vehicle VH.

The plan creating unit 12 creates, using the inter-vehicle distance d indicated by the distance information and the target inter-vehicle distance d*, a distance plan dₚₗₐₙ indicating changes over time of the inter-vehicle distance, a speed plan vₚₗₐₙ indicating changes over time of the speed of the host vehicle VH, and an acceleration plan aₚₗₐₙ indicating changes over time of the acceleration of the host vehicle VH, for a period during which the host vehicle VH is following the preceding vehicle VL (step ST3 of FIG. 5).

The plan creating unit 12 outputs each of the distance plan dₚₗₐₙ and the speed plan vₚₗₐₙ to the vehicle control unit 13, and outputs the acceleration plan aₚₗₐₙ to the instruction integrating unit 14.

A process of creating the distance plan dₚₗₐₙ etc., by the plan creating unit 12 will be specifically described below.

The plan creating unit 12 defines, as shown in the following expression (3), an input distance dᵢₙ as a step input to 0 from a deviation (d₀−d*₀) between an inter-vehicle distance initial value do which is an initial value of the inter-vehicle distance d and a target inter-vehicle distance initial value d*₀ which is an initial value of the target inter-vehicle distance d*.

$${d}_{i n} = \{ \begin{matrix}{d}_{0} - {d}_{0}^{*} & ( t = 0 ) \\ 0 & ( t > 0 )\end{matrix} \qquad ( 3 )$$

The plan creating unit 12 provides the input distance dᵢₙ to a digital filter F_{d}(s) shown in expression (5), and thereby obtains F_{d}(s)dᵢₙ from the digital filter F_{d}(s).

The plan creating unit 12 calculates a distance plan dₚₗₐₙ from F_{d}(s)dᵢₙ and the target inter-vehicle distance d* as shown in the following expression (4).

$${d}_{plan} = {F}_{d} ( s ) {d}_{i n} + {d}^{*} \qquad ( 4 )$$

$${F}_{d} ( s ) = \frac{{ω}_{d}^{2}}{{s}^{2} + 2 {ζ}_{d} {ω}_{d} s + {ω}_{d}^{2}} \qquad ( 5 )$$

The digital filter F_{d}(s) is a second-order filter with an attenuation coefficient and a control response ω_{d}. Whether or not there is undershoot of the inter-vehicle distance d when the inter-vehicle distance d converges to the target inter-vehicle distance d* is determined by the attenuation coefficient ζ_{d}. If ζ_{d}=1, then the inter-vehicle distance d converges to the target inter-vehicle distance d* without the inter-vehicle distance d experiencing undershoot. If ζ_{d}<1, then the inter-vehicle distance d experiences undershoot and then converges to the target inter-vehicle distance d*. How quickly the inter-vehicle distance d converges to the target inter-vehicle distance d* is determined by the control response ω_{d}.

Then, the plan creating unit 12 calculates, as shown in the following expression (6), a speed plan vₚₗₐₙ by subtracting a differential value of F_{d}(s)dᵢₙ from the speed v_{lead} of the preceding vehicle VL.

$${v}_{plan} = {v}_{lead} - \frac{d}{d t} \{ {F}_{d} ( s ) {d}_{i n} \} \qquad ( 6 )$$

Finally, the plan creating unit 12 creates, as shown in the following expression (7), an acceleration plan aₚₗₐₙ by adding a negative sign to a second-order differential value of F_{d}(s)dᵢₙ.

$${a}_{plan} = - \frac{d}{d t} \{ {F}_{d} ( s ) {d}_{i n} \} \qquad ( 7 )$$

The vehicle control unit 13 obtains each of the distance information and the host vehicle speed information from the information obtaining unit 11.

In addition, the vehicle control unit 13 obtains each of the distance plan dₚₗₐₙ and the speed plan vₚₗₐₙ from the plan creating unit 12.

The vehicle control unit 13 calculates, as shown in the following expression (8), an acceleration control signal a_{ctrl} for controlling acceleration a of the host vehicle VH from a deviation (d−dₚₗₐₙ) between the inter-vehicle distance d indicated by the distance information and the distance plan dₚₗₐₙ and a deviation (vₚₗₐₙ−v) between the speed plan vₚₗₐₙ and the speed v of the host vehicle VH indicated by the host vehicle speed information (step ST4 of FIG. 5).

a_{ctrl}=K_{dp}(d−dₚₗₐₙ)+K_{dd}(vₚₗₐₙ−v) (8)

In expression (8), K_{dp} is the proportional gain for inter-vehicle distance control and K_{dd} is the derivative gain for inter-vehicle distance control.

Here, the vehicle control unit 13 calculates the acceleration control signal a_{ctrl} using expression (8). However, this is merely an example, and the vehicle control unit 13 may calculate the acceleration control signal a_{ctrl} by substituting the speed plan vₚₗₐₙ and the speed v of the host vehicle VH into the following expression (9).

$${a}_{ctrl} = ( {K}_{sp} + \frac{{K}_{si}}{s} ) ( {v}_{plan} - v ) \qquad ( 9 )$$

In expression (9), Kₛₚ is the proportional gain for speed control and Kₛᵢ is the integral gain for speed control.

The vehicle control unit 13 outputs the acceleration control signal a_{ctrl} to the instruction integrating unit 14.

The instruction integrating unit 14 obtains the acceleration plan aₚₗₐₙ from the plan creating unit 12, and obtains the acceleration control signal anal from the vehicle control unit 13.

The instruction integrating unit 14 generates, as shown in the following expression (10), an acceleration instruction a_{ref} which is to be provided to the driving and braking control apparatus 4 of the host vehicle VH, by calculating the sum of the acceleration control signal a_{ctrl} and the acceleration plan aₚₗₐₙ (step ST5 of FIG. 5).

a_{ref}=aₚₗₐₙ+a_{ctrl} (10)

The instruction integrating unit 14 outputs the acceleration instruction a_{ref} to the driving and braking control apparatus 4.

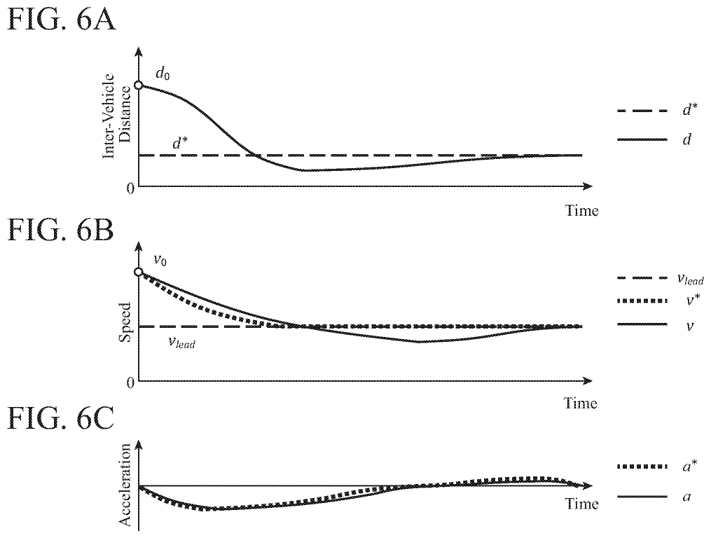

Here, FIG. 6 is an explanatory diagram showing an exemplary operation of the vehicle control apparatus disclosed in Patent Literature 1.

FIG. 6 shows an operation performed when a host vehicle VH follows a preceding vehicle VL lower in speed than the host vehicle VH.

FIG. 6A shows changes over time of an inter-vehicle distance d between the host vehicle VH and the preceding vehicle VL. FIG. 6B shows changes over time of speed v of the host vehicle VH. FIG. 6C shows changes over time of acceleration a of the host vehicle VH.

In the vehicle control apparatus disclosed in Patent Literature 1, the calculating unit calculates target speed v* of the host vehicle VH on the basis of the inter-vehicle distance d between the host vehicle VH and the preceding vehicle VL and speed v_{lead} of the preceding vehicle VL. Then, the travel control unit calculates an acceleration instruction a* that causes the speed v of the host vehicle VH to match the target speed v*. In this case, if a control response of the travel control unit is slow, then a dangerous situation may occur in which the host vehicle VH gets too close to the preceding vehicle VL and collides with the preceding vehicle VL. On the other hand, if a control response of the travel control unit is fast, then fluctuations in speed such as repetition of an increase and a decrease in the speed v of the host vehicle VH may occur.

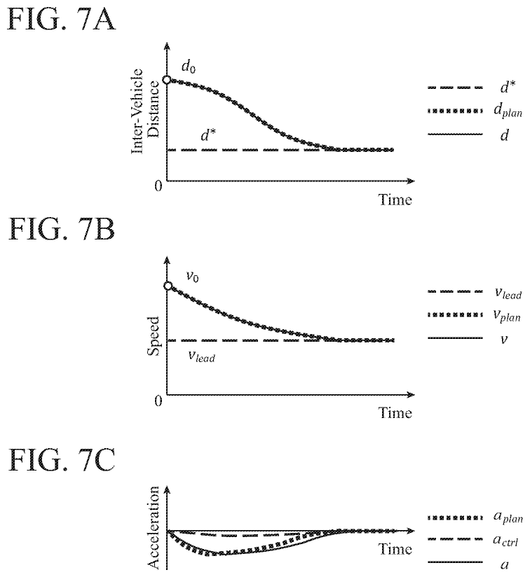

FIG. 7 is an explanatory diagram showing an exemplary operation of the vehicle driving assistance apparatus 3 shown in FIG. 2.

FIG. 7 shows an operation performed when the host vehicle VH follows the preceding vehicle VL lower in speed than the host vehicle VH.

FIG. 7A shows a distance plan dₚₗₐₙ, FIG. 7B shows a speed plan vₚₗₐₙ, and FIG. 7C shows an acceleration plan aₚₗₐₙ.

In an example of FIG. 7, since the speed v_{lead} of the preceding vehicle VL is a constant speed, a target inter-vehicle distance d* which is calculated on the basis of the speed v_{lead} of the preceding vehicle VL has a constant value as shown in FIG. 7A. The distance plan dₚₗₐₙ is calculated as changes over time of the inter-vehicle distance d from an initial value do to convergence to the target inter-vehicle distance d*.

The speed plan vₚₗₐₙ is calculated, as shown in FIG. 7B, as changes over time of the speed v of the host vehicle VH from an initial value v₀ to convergence to the speed v_{lead} of the preceding vehicle VL.

The acceleration plan aₚₗₐₙ is calculated as changes over time of deceleration of the host vehicle VH for implementing each of the distance plan dₚₗₐₙ and the speed plan vₚₗₐₙ.

When the driving and braking control apparatus 4 ideally operates and thereby the acceleration a of the host vehicle VH occurs as intended by the acceleration plan aₚₗₐₙ, the inter-vehicle distance d accurately follows the distance plan dₚₗₐₙ, and the speed v of the host vehicle VH accurately follows the speed plan vₚₗₐₙ. Hence, an acceleration control signal a_{ctrl} which is calculated on the basis of a deviation between the inter-vehicle distance d and the distance plan dₚₗₐₙ and a deviation between the speed plan vₚₗₐₙ and the speed v of the host vehicle VH is substantially 0.

Thus, thanks to the vehicle driving assistance apparatus 3 shown in FIG. 2, the host vehicle VH can follow the preceding vehicle VL without causing a dangerous situation in which the host vehicle VH gets too close to the preceding vehicle VL and collides with the preceding vehicle VL. In addition, in the vehicle driving assistance apparatus 3 shown in FIG. 2, the instruction integrating unit 14 generates an acceleration instruction a_{ref} using the acceleration plan aₚₗₐₙ. Therefore, even if a control response of the vehicle control unit 13 to the acceleration control signal a_{ctrl} is slow, each of the distance plan dₚₗₐₙ and the speed plan vₚₗₐₙ can be implemented. Thus, fluctuations in speed such as repetition of an increase and a decrease in the speed v of the host vehicle VH can be suppressed.

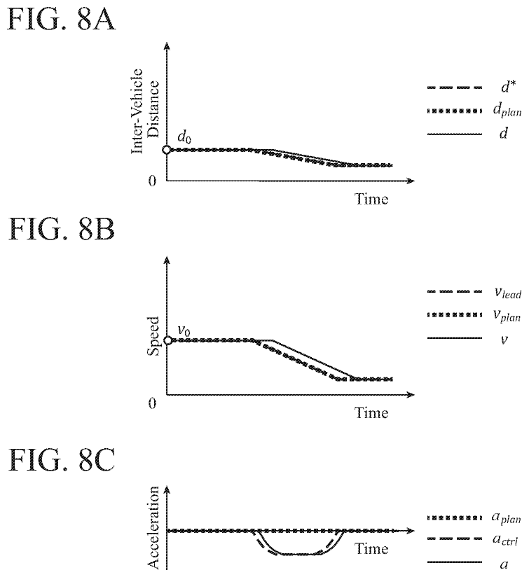

FIG. 8 is an explanatory diagram showing an exemplary operation of the vehicle driving assistance apparatus 3 shown in FIG. 2.

FIG. 8 shows an operation performed when the host vehicle VH follows the preceding vehicle VL having decelerated when the inter-vehicle distance d between the host vehicle VH and the preceding vehicle VL maintains the target inter-vehicle distance d*.

FIG. 8A shows a distance plan dₚₗₐₙ, FIG. 8B shows a speed plan vₚₗₐₙ, and FIG. 8C shows an acceleration plan aₚₗₐₙ.

In an example of FIG. 8, since the speed view of the preceding vehicle VL has decelerated, as shown in FIG. 8A, a target inter-vehicle distance d* which is calculated on the basis of the speed v_{lead} of the preceding vehicle VL decreases with the speed view of the preceding vehicle VL. In addition, since F_{d}(s)dᵢₙ shown in the first term on the right hand side of expression (4) which is obtained when the inter-vehicle distance d maintains the target inter-vehicle distance d* has converged to 0, the distance plan dₚₗₐₙ matches the target inter-vehicle distance d*.

Since F_{d}(s)dᵢₙ obtained when the inter-vehicle distance d maintains the target inter-vehicle distance d* has converged to 0, the speed plan vₚₗₐₙ matches the speed v_{lead} of the preceding vehicle VL.

Since F_{d}(s)dᵢₙ obtained when the inter-vehicle distance d maintains the target inter-vehicle distance d* has converged to 0, the acceleration plan aₚₗₐₙ is 0.

In the vehicle driving assistance apparatus 3 shown in FIG. 2, the vehicle control unit 13 calculates an acceleration control signal a_{ctrl} in such a way as to implement a distance plan dₚₗₐₙ that decreases with the speed v_{lead} of the preceding vehicle VL and a speed plan vₚₗₐₙ that decreases with the speed v_{lead} of the preceding vehicle VL. Namely, the vehicle control unit 13 calculates an acceleration control signal a_{ctrl} from a deviation between the inter-vehicle distance d and the distance plan dₚₗₐₙ and a deviation between the speed plan vₚₗₐₙ and the speed v of the host vehicle VH. Thus, even if the preceding vehicle VL decelerates when the inter-vehicle distance d between the host vehicle VH and the preceding vehicle VL maintains the target inter-vehicle distance d*, the host vehicle VH can follow the preceding vehicle VL.

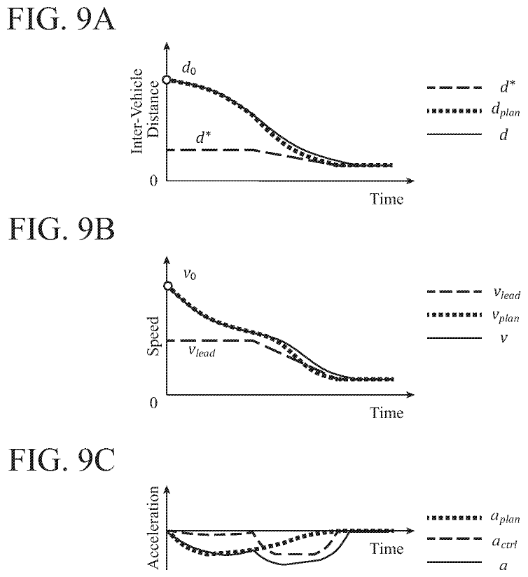

FIG. 9 is an explanatory diagram showing an exemplary operation of the vehicle driving assistance apparatus 3 shown in FIG. 2.

FIG. 9 shows an operation performed when the host vehicle VH follows the preceding vehicle VL having decelerated before the speed v of the host vehicle VH converges to the speed v_{lead} of the preceding vehicle VL.

FIG. 9A shows a distance plan dₚₗₐₙ, FIG. 9B shows a speed plan vₚₗₐₙ, and FIG. 9C shows an acceleration plan aₚₗₐₙ.

In the vehicle driving assistance apparatus 3 shown in FIG. 2, the vehicle control unit 13 calculates an acceleration control signal a_{ctrl} in such a way as to implement a distance plan dₚₗₐₙ that decreases with the speed v_{lead} of the preceding vehicle VL and a speed plan vₚₗₐₙ that decreases with the speed v_{lead} of the preceding vehicle VL. Namely, the vehicle control unit 13 calculates an acceleration control signal a_{ctrl} from a deviation between the inter-vehicle distance d and the distance plan dₚₗₐₙ and a deviation between the speed plan vₚₗₐₙ and the speed v of the host vehicle VH. Thus, even if the preceding vehicle VL decelerates before the inter-vehicle distance d between the host vehicle VH and the preceding vehicle VL converges to the target inter-vehicle distance d*, the host vehicle VH can follow the preceding vehicle VL.

In the above-described first embodiment, the vehicle driving assistance apparatus 3 is configured to include the information obtaining unit 11 that obtains, from the first vehicle detection sensor 1 that detects a preceding vehicle which is a vehicle traveling ahead of a host vehicle, distance information indicating an inter-vehicle distance between the host vehicle and the preceding vehicle and relative speed information indicating relative speed of the preceding vehicle with respect to the host vehicle, and obtains host vehicle speed information indicating speed of the host vehicle from the speed sensor 2; and the plan creating unit 12 that calculates a target inter-vehicle distance which is a target value of the inter-vehicle distance between the host vehicle and the preceding vehicle, from the relative speed information and the host vehicle speed information, and creates, using the inter-vehicle distance indicated by the distance information and the target inter-vehicle distance, a distance plan indicating changes over time of the inter-vehicle distance, a speed plan indicating changes over time of the speed of the host vehicle, and an acceleration plan indicating changes over time of acceleration of the host vehicle, for a period during which the host vehicle is following the preceding vehicle. In addition, the vehicle driving assistance apparatus 3 includes the vehicle control unit 13 that calculates an acceleration control signal for controlling the acceleration of the host vehicle, using the distance information, the distance plan, the host vehicle speed information, and the speed plan; and the instruction integrating unit 14 that generates an acceleration instruction which is to be provided to the driving and braking control apparatus 4 of the host vehicle, using the acceleration control signal calculated by the vehicle control unit 13 and the acceleration plan. Thus, the vehicle driving assistance apparatus 3 can prevent each of occurrence of a situation in which the host vehicle gets too close to the preceding vehicle and occurrence of a situation of fluctuations in the speed of the host vehicle, during a period during which the host vehicle is following the preceding vehicle.

In the vehicle driving assistance apparatus 3 shown in FIG. 2, the plan creating unit 12 creates, using the digital filter F_{d}(s), a first distance plan dₚₗₐₙ indicating changes over time of the inter-vehicle distance, for a period during which the host vehicle VH is following the preceding vehicle VL. However, the digital filter F_{d}(s) used by the plan creating unit 12 is not limited to the second-order filter shown in expression (5), and the plan creating unit 12 may use, for example, a two-stage moving average filter shown in the following expression (11), as the digital filter F_{d}(s). The two-stage moving average filter shown in expression (11) is a filter obtained by combining together two moving average filters Fₐᵥₑ(s) shown in the following expression (12).

$${F}_{d} ( s ) = [ \frac{1}{{τ}_{1 d}} \frac{1 - {e}^{- {τ}_{1 d} s}}{s} ] [ \frac{1}{{τ}_{2 d}} \frac{1 - {e}^{- {τ}_{2 d} s}}{s} ] \qquad ( 11 )$$

$${F}_{ave} ( s ) = [ \frac{1}{{τ}_{d}} \frac{1 - {e}^{- {τ}_{d} s}}{s} ] \qquad ( 12 )$$

In expressions (11) and (12), each of τ_{d}, τ_{1d}, and τ_{2d} is the time constant of the moving average filters.

### Second Embodiment

In a second embodiment, a vehicle driving assistance apparatus 3 including a vehicle control unit 15 instead of the vehicle control unit 13 shown in FIG. 2 will be described.

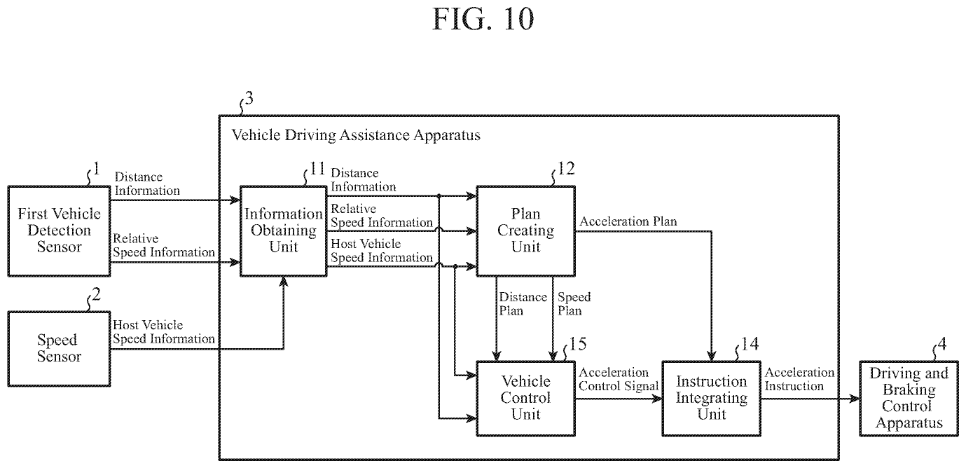

FIG. 10 is a configuration diagram showing a vehicle control apparatus including the vehicle driving assistance apparatus 3 according to the second embodiment. In FIG. 10, the same reference signs as those of FIG. 2 indicate the same or corresponding portions, and thus, description thereof is omitted.

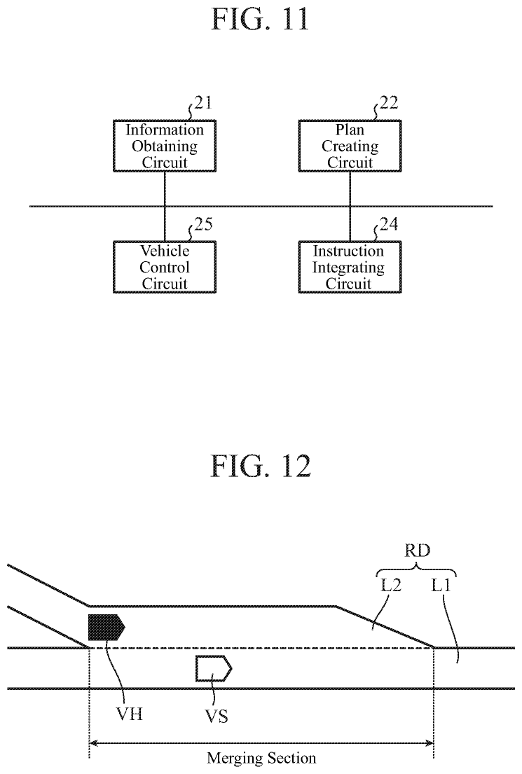

FIG. 11 is a hardware configuration diagram showing hardware of the vehicle driving assistance apparatus 3 according to the second embodiment. In FIG. 11, the same reference signs as those of FIG. 3 indicate the same or corresponding portions, and thus, description thereof is omitted.

The vehicle control unit 15 is implemented by, for example, a vehicle control circuit 25 shown in FIG. 11.

The vehicle control unit 15 determines, using a dynamic vehicle model indicating behavior of the host vehicle VH, a predicted inter-vehicle distance dₖ which is a predicted value of the inter-vehicle distance d between the host vehicle VH and the preceding vehicle VL, and predicted speed vₖ which is a predicted value of the speed v of the host vehicle VH.

The vehicle control unit 15 evaluates each of a deviation between a distance plan dₚₗₐₙ and the predicted inter-vehicle distance dₖ and a deviation between a speed plan vₚₗₐₙ and the predicted speed vₖ, and calculates an acceleration control signal a_{ctrl} on the basis of an evaluation value of the deviations.

In FIG. 10, it is assumed that each of the information obtaining unit 11, the plan creating unit 12, the vehicle control unit 15, and the instruction integrating unit 14 which are the components of the vehicle driving assistance apparatus 3 is implemented by dedicated hardware such as that shown in FIG. 11. Namely, it is assumed that the vehicle driving assistance apparatus 3 is implemented by the information obtaining circuit 21, the plan creating circuit 22, the vehicle control circuit 25, and the instruction integrating circuit 24.

Each of the information obtaining circuit 21, the plan creating circuit 22, the vehicle control circuit 25, and the instruction integrating circuit 24 corresponds, for example, to a single circuit, a combined circuit, a programmed processor, a parallel programmed processor, an ASIC, an FPGA, or a combination thereof.

The components of the vehicle driving assistance apparatus 3 are not limited to being implemented by dedicated hardware, and the vehicle driving assistance apparatus 3 may be implemented by software, firmware, or a combination of software and firmware.

When the vehicle driving assistance apparatus 3 is implemented by software, firmware, or the like, a program for causing a computer to perform processing procedures performed in the information obtaining unit 11, the plan creating unit 12, the vehicle control unit 15, and the instruction integrating unit 14 is stored in the memory 31 shown in FIG. 4. Then, the processor 32 shown in FIG. 4 executes the program stored in the memory 31.

In addition, FIG. 11 shows an example in which each of the components of the vehicle driving assistance apparatus 3 is implemented by dedicated hardware, and FIG. 4 shows an example in which the vehicle driving assistance apparatus 3 is implemented by software, firmware, or the like. However, they are merely examples, and some of the components of the vehicle driving assistance apparatus 3 may be implemented by dedicated hardware and the other components may be implemented by software, firmware, or the like.

Next, operations of the vehicle control apparatus shown in FIG. 10 will be described. All components other than the vehicle control unit 15 are the same as those of the vehicle control apparatus shown in FIG. 2. Hence, here, only the operations of the vehicle control unit 15 will be described.

The dynamic vehicle model indicating behavior of the host vehicle VH predicts behavior of the host vehicle VH for a period of time from a current time t(0) to the future ahead by time Th at intervals of a constant period Tₚₑᵣ.

The vehicle control unit 15 solves, every constant period, an optimization problem that determines a control input u that minimizes an evaluation function J that evaluates each of a deviation between the distance plan dₚₗₐₙ and the predicted inter-vehicle distance dₖ and a deviation between the speed plan vₚₗₐₙ and the predicted speed vₖ, and then the vehicle control unit 15 calculates each solution as an acceleration control signal a_{ctrl}.

In this case, the number of points of each of the predicted inter-vehicle distance dₖ and the predicted speed vₖ which are vehicle state quantities to be predicted is N. N=Th/Tₚₑᵣ. The period of time from the current time t(0) to the future ahead by the time Th is referred to as “horizon”.

A process of calculating the acceleration control signal a_{ctrl} by the vehicle control unit 15 will be specifically described below.

The following expression (13) shows determination of the control input u that minimizes the evaluation function J.

minᵤJ (13)

\dot{x}=ƒ(x,u) (14)

x₀=x(0) (15)

In expressions (13) to (15), x is the vehicle state quantity and x₀ is the initial value of the vehicle state quantity x.

x-dot is the predicted value of the vehicle state quantity x. In the text of the specification, due to electronic filing, “•” cannot be placed above the letter “x”, and thus, it is represented as x-dot.

f(x, u) is the vector-valued function for the dynamic vehicle model.

The vehicle control unit 15 sets the vehicle state quantity x as shown in the following expression (16), and sets the control input u as shown in the following expression (17).

x=[d,v,a]^{T} (16)

u=[a_{ctrl}]^{T} (17)

In expressions (16) and (17), d is the inter-vehicle distance between the host vehicle VH and the preceding vehicle VL, v is the speed of the host vehicle VH, and a is the acceleration of the host vehicle VH. In addition, a_{ctrl} is the acceleration control signal.

The dynamic vehicle model used by the vehicle control unit 15 is represented as shown in the following expression (18).

$$\dot{x} = f ( x , u ) = [ \begin{matrix}{v}_{lead} - v \\ a \\ \frac{1}{{T}_{a}} ( {a}_{plan} + {a}_{ctrl} - a )\end{matrix} ] \qquad ( 18 )$$

In expression (18), Ta is the response delay of the driving and braking control apparatus 4 with respect to the acceleration instruction a_{ref}.

The evaluation function J used by the vehicle control unit 15 is represented as shown in the following expression (19).

$$J = {( {h}_{N} ( {x}_{N} ) - {r}_{N} )}^{T} {W}_{N} ( {h}_{N} ( {x}_{N} ) - {r}_{N} ) + {\sum }_{k = 0 }^{N - 1} {( h ( {x}_{k} , {u}_{k} ) - {r}_{k} )}^{T} W ( h ( {x}_{k} , {u}_{k} ) - {r}_{k} ) \qquad ( 19 )$$

In expression (19), xₖ is the predicted value of the vehicle state quantity at a predicted point k (k=0, . . . , N), and uₖ is the control input at a predicted point k (k=0, . . . , N−1).

h is the vector-valued function for evaluation items. h_{N} is the vector-valued function for the evaluation items at the predicted point N, and rₖ is the target value at the predicted point k (k=0, . . . , N). Each of W and W_{N} is a weighting matrix and is a diagonal matrix in which a weight for each evaluation item is included in a diagonal element.

The vehicle control unit 15 sets the vector-valued function h for evaluation items as shown in the following expression (20), and sets the vector-valued function h_{N} for the evaluation items as shown in the following expression (21).

h=[dₖ,vₖ,a_{k,ctrl}]^{T} (20)

h_{N}=[d_{N},v_{N}]^{T} (21)

In expression (20), dₖ is the predicted inter-vehicle distance which is a predicted value of the inter-vehicle distance at the predicted point k (k=0, N), and vₖ is the predicted speed which is a predicted value of the speed of the host vehicle VH at the predicted point k (k=0, . . . , N).

The vehicle control unit 15 sets each of a target value rₖ shown in the following expression (22) and a target value r_{N} shown in the following expression (23) so that each of the predicted inter-vehicle distance dₖ and the predicted speed vₖ decreases.

rₖ=[d_{plan,k},v_{plan,k},0]^{T} (22)

r_{N}=[d_{plan,N},v_{plan,N}]^{T} (23)

In expressions (22) and (23), d_{plan, k} is the value at the predicted point k in the distance plan dₚₗₐₙ shown in expression (4), and d_{plan, N} is the value at the predicted point N in the distance plan dₚₗₐₙ shown in expression (4).

v_{plan, k} is the value at the predicted point k in the speed plan vₚₗₐₙ shown in expression (6), and v_{plan, N} is the value at the predicted point N in the speed plan vₚₗₐₙ shown in expression (6).

The vehicle control unit 15 evaluates each of a deviation between the predicted inter-vehicle distance dₖ and the target value rₖ and a deviation between the predicted speed vₖ and the target value rₖ, using the evaluation function J shown in expression (19).

The vehicle control unit 15 solves, every constant period, an optimization problem that determines a control input u at which an evaluation value of the deviations is minimized, and calculates each solution as an acceleration control signal a_{ctrl}. A process itself of solving an optimization problem is a publicly known technique and thus a detailed description thereof is omitted.

Then, the instruction integrating unit 14 generates, as shown in expression (10), an acceleration instruction a_{ref} which is to be provided to the driving and braking control apparatus 4, by integrating the acceleration plan aₚₗₐₙ and the acceleration control signal a_{ctrl}.

Similarly to the vehicle driving assistance apparatus 3 shown in FIG. 2, the vehicle driving assistance apparatus 3 shown in FIG. 10 also makes it possible for the host vehicle VH to follow the preceding vehicle VL.

In the vehicle driving assistance apparatus 3 shown in FIG. 10, the vehicle control unit 15 determines a control input u at which an evaluation value of the deviations is minimized. However, this is merely an example, and the vehicle control unit 15 may determine a control input u at which an evaluation value of the deviations is smaller than a threshold value set beforehand.

In addition, if the vehicle control unit 15 cannot determine a control input u at which the evaluation value of the deviations is smaller than the threshold value even by performing iteration computation a predetermined number of times, then the vehicle control unit 15 may determine a control input u at which the smallest evaluation value among a plurality of evaluation values determined by the iteration computation is obtained.

In the vehicle driving assistance apparatus 3 shown in FIG. 10, the vehicle control unit 15 determines a control input u at which an evaluation value of the deviations is minimized. However, this is merely an example. The sign of the evaluation function J may be reversed, and the vehicle control unit 15 may determine a control input u at which an evaluation value of the deviations is maximized. In addition, the vehicle control unit 15 may determine a control input u at which an evaluation value of the deviations is greater than a threshold value set beforehand.

In addition, if the vehicle control unit 15 cannot determine a control input u at which the evaluation value of the deviations is greater than the threshold value even by performing iteration computation a predetermined number of times, then the vehicle control unit 15 may determine a control input u at which the largest evaluation value among a plurality of evaluation values determined by the iteration computation is obtained.

In the vehicle driving assistance apparatus 3 shown in FIG. 10, by evaluating deviation from a distance plan and deviation from a speed plan, an acceleration control instruction for smoothly following each of the distance plan and the speed plan in the horizon can be calculated. Furthermore, by incorporating a response delay of the driving and braking control apparatus 4 into the dynamic vehicle model, the amount of control taking into account a delay of the vehicle with respect to an acceleration instruction can be calculated.

### Third Embodiment

In a third embodiment, a vehicle driving assistance apparatus 3 including an information obtaining unit 41, a plan creating unit 42, a vehicle control unit 43, and an instruction integrating unit 44 will be described.

FIG. 12 is an explanatory diagram showing a host vehicle VH on which the vehicle driving assistance apparatus 3 according to the third embodiment is mounted, and a side vehicle VS traveling in a lane to which the host vehicle VH makes a lane change.

A road RD on which each of the host vehicle VH and the side vehicle VS travels has a main lane L1 and a merging lane L2. The main lane L1 and the merging lane L2 are connected to each other in a merging section of the road RD. In the drawing, a dashed-line section is the merging section.

In the road RD shown in FIG. 12, the main lane L1 and the merging lane L2 are parallel to each other. However, this is merely an example, and the main lane L1 and the merging lane L2 may be lanes which are not parallel to each other.

In FIG. 12, the host vehicle VH is traveling in the merging lane L2 and the side vehicle VS is traveling in the main lane L1.

The side vehicle VS is a vehicle traveling ahead of the host vehicle VH. If there are a plurality of vehicles traveling ahead in the main lane L1, then of the plurality of vehicles, a vehicle with the shortest distance from the host vehicle VH is the side vehicle VS.

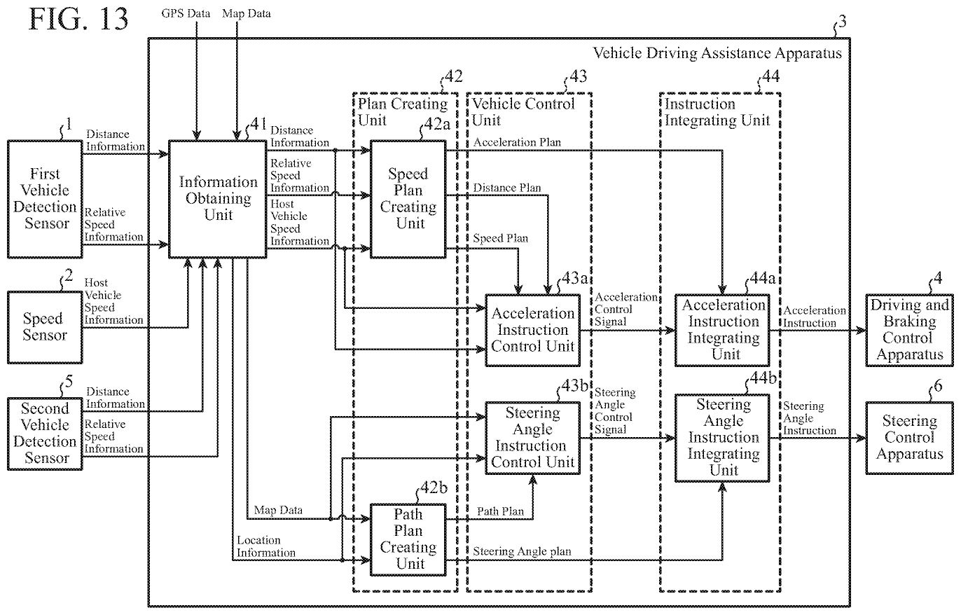

The vehicle driving assistance apparatus 3 shown in FIG. 13 generates a steering angle instruction δ_{ref} which is to be provided to a steering control apparatus 6 of the host vehicle VH, so that the host vehicle VH makes a lane change from the merging lane L2 to the main lane L1. In addition, the vehicle driving assistance apparatus 3 shown in FIG. 13 sets the side vehicle VS as a preceding vehicle VL of the host vehicle VH, and generates an acceleration instruction a_{ref} which is to be provided to the driving and braking control apparatus 4 of the host vehicle VH, so that the host vehicle VH travels following the side vehicle VS.

FIG. 13 is a configuration diagram showing a vehicle control apparatus including the vehicle driving assistance apparatus 3 according to the third embodiment. In FIG. 13, the same reference signs as those of FIGS. 2 and 10 indicate the same or corresponding portions, and thus, description thereof is omitted.

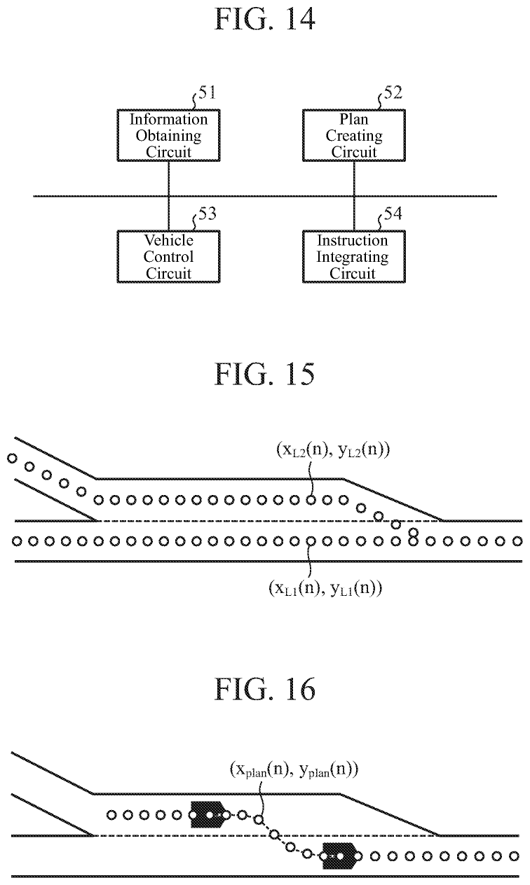

FIG. 14 is a hardware configuration diagram showing hardware of the vehicle driving assistance apparatus 3 according to the third embodiment. In FIG. 14, the same reference signs as those of FIGS. 3 and 11 indicate the same or corresponding portions, and thus, description thereof is omitted.

A second vehicle detection sensor 5 is installed in the host vehicle VH.

The second vehicle detection sensor 5 detects the side vehicle VS traveling in the main lane L1.

The second vehicle detection sensor 5 calculates each of an inter-vehicle distance d between the host vehicle VH and the side vehicle VS and relative speed vᵣₑₗ of the side vehicle VS with respect to the host vehicle VH.

In the vehicle driving assistance apparatus 3 shown in FIG. 13, for convenience of description, the inter-vehicle distance between the host vehicle VH and the side vehicle VS is also represented as d as with the inter-vehicle distance between the host vehicle VH and the preceding vehicle VL. In addition, the relative speed of the side vehicle VS is also represented as vᵣₑₗ as with the relative speed of the preceding vehicle VL.

The second vehicle detection sensor 5 outputs distance information indicating the inter-vehicle distance d and relative speed information indicating the relative speed vᵣₑₗ of the side vehicle VS to the vehicle driving assistance apparatus 3.

In the vehicle driving assistance apparatus 3 shown in FIG. 13, the second vehicle detection sensor 5 calculates each of the inter-vehicle distance d and the relative speed vᵣₑₗ of the side vehicle VS. However, this is merely an example, and the vehicle control apparatus may include a sensor that can calculate the inter-vehicle distance d and a sensor that can calculate the relative speed vᵣₑₗ of the side vehicle VS, instead of the second vehicle detection sensor 5.

The steering control apparatus 6 controls a steering apparatus (not shown) of the host vehicle VH on the basis of a steering angle instruction δ_{ref} outputted from the vehicle driving assistance apparatus 3.

The vehicle driving assistance apparatus 3 shown in FIG. 13 includes the information obtaining unit 41, the plan creating unit 42, the vehicle control unit 43, and the instruction integrating unit 44.

The plan creating unit 42 includes a path plan creating unit 42b in addition to a speed plan creating unit 42a corresponding to the plan creating unit 12 shown in FIG. 2. The vehicle control unit 43 includes a steering angle instruction control unit 43b in addition to an acceleration instruction control unit 43a corresponding to the vehicle control unit 13 shown in FIG. 2. The instruction integrating unit 44 includes a steering angle instruction integrating unit 44b in addition to an acceleration instruction integrating unit 44a corresponding to the instruction integrating unit 14 shown in FIG. 2.

The information obtaining unit 41 is implemented by, for example, an information obtaining circuit 51 shown in FIG. 14.

The information obtaining unit 41 not only performs the same process as that of the information obtaining unit 11 shown in FIG. 2, but also obtains distance information indicating the inter-vehicle distance d between the host vehicle VH and the side vehicle VS and relative speed information indicating the relative speed vᵣₑₗ of the side vehicle VS from the second vehicle detection sensor 5.

If, for example, the second vehicle detection sensor 5 has detected the side vehicle VS when the first vehicle detection sensor 1 has not detected the preceding vehicle VL, then the information obtaining unit 41 outputs relative speed information outputted from the second vehicle detection sensor 5, instead of relative speed information outputted from the first vehicle detection sensor 1, to the plan creating unit 42. In addition, the information obtaining unit 41 outputs distance information outputted from the second vehicle detection sensor 5, instead of distance information outputted from the first vehicle detection sensor 1, to each of the plan creating unit 42 and the vehicle control unit 43.

In addition, the information obtaining unit 41 obtains, from a source external to the vehicle driving assistance apparatus 3, map data indicating a map including a host vehicle's lane which is a lane in which the host vehicle VH is traveling, and a lane to which the host vehicle VH makes a lane change. In an example of FIG. 12, the host vehicle's lane is the merging lane L2 and the lane to which the vehicle makes a lane change is the main lane L1.

In addition, the information obtaining unit 41 includes a global positioning system (GPS) receiver, and checks the location of the host vehicle VH on the basis of GPS data received by the GPS receiver.

The information obtaining unit 41 outputs each of location information indicating the location of the host vehicle VH and the map data to each of the plan creating unit 42 and the vehicle control unit 43.

The plan creating unit 42 is implemented by, for example, a plan creating circuit 52 shown in FIG. 14.

The plan creating unit 42 includes the speed plan creating unit 42a and the path plan creating unit 42b. The speed plan creating unit 42a is the same as the plan creating unit 12 shown in FIG. 2, and thus, a detailed description thereof is omitted.

The path plan creating unit 42b obtains each of the location information and the map data from the information obtaining unit 41.

The path plan creating unit 42b identifies a path for the host vehicle VH to reach the main lane L1 from the merging lane L2, on the basis of neighborhood map data including the location of the host vehicle VH indicated by the location information out of the map data.

The path plan creating unit 42b creates a path plan rₚₗₐₙ indicating changes over time of the travel location of the host vehicle VH on the identified path. rₚₗₐₙ=(xₚₗₐₙ, yₚₗₐₙ).

The path plan creating unit 42b creates, using the path plan rₚₗₐₙ, a steering angle plan δₚₗₐₙ indicating changes over time of the steering angle δ of the host vehicle VH for the host vehicle VH to travel on the identified path.

The path plan creating unit 42b outputs the path plan rₚₗₐₙ to the steering angle instruction control unit 43b and outputs the steering angle plan δₚₗₐₙ to the steering angle instruction integrating unit 44b.

The vehicle control unit 43 is implemented by, for example, a vehicle control circuit 53 shown in FIG. 14.

The vehicle control unit 43 includes the acceleration instruction control unit 43a and the steering angle instruction control unit 43b. The acceleration instruction control unit 43a is the same as the vehicle control unit 13 shown in FIG. 2, and thus, a detailed description thereof is omitted.

The steering angle instruction control unit 43b calculates a steering angle control signal δ_{ctrl} for controlling the steering angle δ of the host vehicle VH, using the path plan roan created by the path plan creating unit 42b.

The steering angle instruction control unit 43b outputs the steering angle control signal δ_{ctrl} to the steering angle instruction integrating unit 44b.

The instruction integrating unit 44 is implemented by, for example, an instruction integrating circuit 54 shown in FIG. 14.

The instruction integrating unit 44 includes the acceleration instruction integrating unit 44a and the steering angle instruction integrating unit 44b. The acceleration instruction integrating unit 44a is the same as the instruction integrating unit 14 shown in FIG. 2, and thus, a detailed description thereof is omitted.

The steering angle instruction integrating unit 44b generates a steering angle instruction δ_{ref} which is to be provided to the steering control apparatus 6 of the vehicle VH, using the steering angle control signal δ_{ctrl} calculated by the steering angle instruction control unit 43b and the steering angle plan δₚₗₐₙ created by the path plan creating unit 42b.

The steering angle instruction integrating unit 44b outputs the steering angle instruction δ_{ref} to the steering control apparatus 6.

In FIG. 13, it is assumed that each of the information obtaining unit 41, the plan creating unit 42, the vehicle control unit 43, and the instruction integrating unit 44 which are the components of the vehicle driving assistance apparatus 3 is implemented by dedicated hardware such as that shown in FIG. 14. Namely, it is assumed that the vehicle driving assistance apparatus 3 is implemented by the information obtaining circuit 51, the plan creating circuit 52, the vehicle control circuit 53, and the instruction integrating circuit 54.

Each of the information obtaining circuit 51, the plan creating circuit 52, the vehicle control circuit 53, and the instruction integrating circuit 54 corresponds, for example, to a single circuit, a combined circuit, a programmed processor, a parallel programmed processor, an ASIC, an FPGA, or a combination thereof.

The components of the vehicle driving assistance apparatus 3 are not limited to being implemented by dedicated hardware, and the vehicle driving assistance apparatus 3 may be implemented by software, firmware, or a combination of software and firmware.

When the vehicle driving assistance apparatus 3 is implemented by software, firmware, or the like, a program for causing a computer to perform processing procedures performed in the information obtaining unit 41, the plan creating unit 42, the vehicle control unit 43, and the instruction integrating unit 44 is stored in the memory 31 shown in FIG. 4. Then, the processor 32 shown in FIG. 4 executes the program stored in the memory 31.

In addition, FIG. 14 shows an example in which each of the components of the vehicle driving assistance apparatus 3 is implemented by dedicated hardware, and FIG. 4 shows an example in which the vehicle driving assistance apparatus 3 is implemented by software, firmware, or the like. However, they are merely examples, and some of the components of the vehicle driving assistance apparatus 3 may be implemented by dedicated hardware and the other components may be implemented by software, firmware, or the like.

Next, operations of the vehicle control apparatus shown in FIG. 13 will be described.

The first vehicle detection sensor 1 detects a preceding vehicle VL.

In the example of FIG. 12, since a preceding vehicle VL traveling in the same merging lane L2 as the host vehicle VH is not present, the preceding vehicle VL is not detected.

The second vehicle detection sensor 5 detects a side vehicle VS, and calculates each of an inter-vehicle distance d between the host vehicle VH and the side vehicle VS and relative speed vᵣₑₗ of the side vehicle VS by the same methods as those used by the first vehicle detection sensor 1.

The second vehicle detection sensor 5 outputs each of distance information indicating the inter-vehicle distance d between the host vehicle VH and the side vehicle VS and relative speed information indicating the relative speed vᵣₑₗ of the side vehicle VS to the information obtaining unit 41 in the vehicle driving assistance apparatus 3.

The information obtaining unit 41 obtains the distance information indicating the inter-vehicle distance d between the host vehicle VH and the side vehicle VS and the relative speed information indicating the relative speed vᵣₑₗ of the side vehicle VS from the second vehicle detection sensor 5.

In addition, the information obtaining unit 41 obtains host vehicle speed information indicating speed v of the host vehicle VH from the speed sensor 2.

The information obtaining unit 41 outputs the relative speed information to the speed plan creating unit 42a, and outputs the host vehicle speed information to each of the speed plan creating unit 42a and the acceleration instruction control unit 43a.

In addition, the information obtaining unit 41 outputs the distance information to each of the speed plan creating unit 42a and the acceleration instruction control unit 43a.

The information obtaining unit 41 checks the location of the host vehicle VH on the basis of GPS data received by the GPS receiver.

The information obtaining unit 41 obtains map data from a source external to the vehicle driving assistance apparatus 3.

The information obtaining unit 41 outputs each of location information indicating the location of the host vehicle VH and the map data to each of the path plan creating unit 42b and the steering angle instruction control unit 43b.

The path plan creating unit 42b obtains each of the location information and the map data from the information obtaining unit 41.

The path plan creating unit 42b identifies a path for the host vehicle VH to reach the main lane L1 from the merging lane L2, on the basis of neighborhood map data including the location of the host vehicle VH indicated by the location information out of the map data. The path may be any path as long as the path goes through the merging section, and for example, a possible path is one that goes through approximately the midpoint of the merging section.

FIG. 15 is an explanatory diagram showing a neighborhood map including the location of the host vehicle VH. In FIG. 15, ∘ shown in each of the main lane L1 and the merging lane L2 indicates a location on a path in the corresponding one of the main lane L1 and the merging lane L2.

(x_{L1}(n), y_{L1}(n)) indicates a location on the path in the main lane L1, and (x_{L2}(n), y_{L2}(n)) indicates a location on the path in the merging lane L2.

FIG. 16 is an explanatory diagram showing a path for the host vehicle VH to reach the main lane L1 from the merging lane L2. In FIG. 16, ∘ indicates a location on the path for the host vehicle VH to reach the main lane L1 from the merging lane L2.

The path plan creating unit 42b creates a path plan rₚₗₐₙ indicating changes over time of the travel location of the host vehicle VH on the path for the host vehicle VH to reach the main lane L1 from the merging lane L2.

In FIG. 16, (xₚₗₐₙ(n), yₚₗₐₙ(n)) indicates the travel location of the host vehicle VH on the path for the host vehicle VH to reach the main lane L1 from the merging lane L2.

The path plan creating unit 42b outputs the path plan rₚₗₐₙ to the steering angle instruction control unit 43b.

A process of creating the path plan rₚₗₐₙ by the path plan creating unit 42b will be specifically described below.

First, the path plan creating unit 42b calculates a coefficient k(n) using a step input kᵢₙ and a filter F_{lc}(s) as shown in the following expression (24).

The coefficient k(n) is a value between 0 and 1, inclusive. When k(n)=1, a lane change of the host vehicle VH from the merging lane L2 to the main lane L1 has not started. When k(n)=0, a lane change of the host vehicle VH from the merging lane L2 to the main lane L1 has been completed.

k(n)=F_{lc}(s)kᵢₙ (24)

The step input kᵢₙ is a signal provided to the filter F_{lc}(s) and is represented as shown in the following expression (25). The coefficient k(n) is the output value of the filter F_{lc}(s).

t represents the time, and t=0 indicates a time at which the host vehicle VH starts merging. t=Tₛ indicates a time at which the host vehicle VH starts a lane change.

$${k}_{i n} = \{ \begin{matrix}1 ( t < {T}_{s} ) \\ 0 ( t \geq {T}_{s} )\end{matrix} \qquad ( 25 )$$

The filter F_{lc}(s) is a filter in which a moving average filter with a time constant of T_{lc}/2 is performed twice, and is represented as shown in the following expression (26). T_{lc} is the time required for the host vehicle VH to reach the main lane L1 from the merging lane L2.

The filter F_{lc}(s) shown in expression (26) can also be represented as shown in the following expression (27) by Pade approximation.

$${F}_{lc} ( s ) = [ \frac{1}{( {T}_{lc} / 2 )} \frac{1 - {e}^{- ( {T}_{lc} / 2 ) s}}{s} ] [ \frac{1}{( {T}_{lc} / 2 )} \frac{1 - {e}^{- ( {T}_{lc} / 2 ) s}}{s} ] \qquad ( 26 )$$

$${F}_{lc} ( s ) = [ \frac{12}{{( {T}_{lc} / 2 )}^{2} {s}^{2} + 6 ( {T}_{lc} / 2 ) s + 12} ] [ \frac{12}{{( {T}_{lc} / 2 )}^{2} {s}^{2} + 6 ( {T}_{lc} / 2 ) s + 12} ] \qquad ( 27 )$$

The path plan creating unit 42b creates a path plan rₚₗₐₙ=(xₚₗₐₙ(n), yₚₗₐₙ(n)), using the coefficient k(n) as shown in the following expressions (28) and (29).

The path plan creating unit 42b outputs the path plan rₚₗₐₙ to the steering angle instruction control unit 43b.

xₚₗₐₙ(n)=(1−k(n))×x_{L1}(n)+k(n)×x_{L2}(n) (28)

yₚₗₐₙ(n)=(1−k(n))×y_{L1}(n)+k(n)×y_{L2}(n) (29)

In addition, the path plan creating unit 42b creates, using the path plan rₚₗₐₙ, a steering angle plan δₚₗₐₙ indicating changes over time of the steering angle δ of the host vehicle VH for the host vehicle VH to travel on a path from the merging lane L2 to the main lane L1.

The path plan creating unit 42b outputs the steering angle plan δₚₗₐₙ to the steering angle instruction integrating unit 44b.

A process of creating the steering angle plan δₚₗₐₙ by the path plan creating unit 42b will be specifically described below.

If the host vehicle VH is making a steady turn, then a transfer function G(s) to a transverse location y of the host vehicle VH at the steering angle δ is represented as shown in the following expression (30). The transverse location y of the host vehicle VH is a location in a direction substantially orthogonal to a traveling direction of the host vehicle VH on a road RD surface.

$$G ( s ) = \frac{1}{{s}^{2}} \frac{{v}^{2}}{( 1 + {Av}^{2} ) l} \qquad ( 30 )$$

$$A = - \frac{M}{2 {l}^{2}} \frac{{l}_{f} {K}_{f} - {l}_{r} {K}_{r}}{{K}_{f} {K}_{r}} \qquad ( 31 )$$

In expressions (30) and (31), A is the stability factor of the host vehicle VH, M is the mass of the host vehicle VH, and l is the wheelbase of the host vehicle VH.

l_{f} is the distance between the location of the center of gravity of the host vehicle VH and a front wheel shaft of the host vehicle VH, and lᵣ is the distance between the location of the center of gravity of the host vehicle VH and a rear wheel shaft of the host vehicle VH.

K_{f} is the cornering power of front wheels of the host vehicle VH, and Kr is the cornering power of rear wheels of the host vehicle VH.

The path plan creating unit 42b creates a steering angle plan δₚₗₐₙ using the filter F_{lc}(s), the transfer function G(s), and an input transverse location yin as shown in the following expression (32).

$${δ}_{plan} = \frac{{F}_{lc} ( s )}{G ( s )} {y}_{i n} \qquad ( 32 )$$

The input transverse location yin is a signal provided to F_{lc}(s)/G(s), and is defined by a step input from 0 to a lane width Y_{RD} as shown in the following expression (33). Thus, a steering angle δ for the host vehicle VH to move over the lane width Y_{RD} is computed by feedforward control.

$${y}_{i n} = \{ \begin{matrix}0 ( t = {T}_{s} ) \\ {Y}_{RD} ( t > {T}_{s} )\end{matrix} \qquad ( 33 )$$

The steering angle instruction control unit 43b obtains each of the location information and the map data from the information obtaining unit 41, and obtains the path plan roan from the path plan creating unit 42b.

The steering angle instruction control unit 43b transforms the path plan rₚₗₐₙ=(xₚₗₐₙ(n), yₚₗₐₙ(n)) into a location point group (x_{VL}(n), y_{VL}(n)) in a host vehicle coordinate system for the host vehicle VH.

A process itself of transforming xₚₗₐₙ(n) into x_{VL}(n) and transforming yₚₗₐₙ(n) into y_{VL}(n) is a publicly known technique and thus a detailed description thereof is omitted.

The steering angle instruction control unit 43b approximates the location point group (x_{VL}(n), y_{VL}(n)) in the host vehicle coordinate system, using a quadratic function as shown in the following expression (34).

y_{VL}(n)=½c2ₚₗₐₙ×x_{VL}(n)²+c1ₚₗₐₙ×x_{VL}(n)+c0ₚₗₐₙ (34)

In expression (34), c0ₚₗₐₙ is the coefficient indicating a transverse location plan, c1ₚₗₐₙ is the coefficient indicating an orientation plan, and c2ₚₗₐₙ is the coefficient indicating a curvature plan.

The steering angle instruction control unit 43b calculates, as shown in the following expression (35), a steering angle control signal δ_{ctrl} using the coefficients c0ₚₗₐₙ and c1ₚₗₐₙ which are determined by expression (34).

The steering angle instruction control unit 43b outputs the steering angle control signal δ_{ctrl} to the steering angle instruction integrating unit 44b.

δ_{ctrl}=k₁·c0ₚₗₐₙ+k₂·c1ₚₗₐₙ+k₃·γ (35)

In expression (35), k₁, k₂, and k₃ each are the control gain and γ is the yaw rate of the host vehicle VH.

The steering angle instruction integrating unit 44b obtains the steering angle plan δₚₗₐₙ from the path plan creating unit 42b, and obtains the steering angle control signal δ_{ctrl} from the steering angle instruction control unit 43b.

The steering angle instruction integrating unit 44b generates, as shown in the following expression (36), a steering angle instruction δ_{ref} which is to be provided to the steering control apparatus 6, by integrating the steering angle plan δₚₗₐₙ and the steering angle control signal δ_{ctrl}.

The steering angle instruction integrating unit 44b outputs the steering angle instruction δ_{ref} to the steering control apparatus 6.

δ_{ref}=δₚₗₐₙ+δ_{ctrl} (36)

The steering control apparatus 6 obtains the steering angle instruction δ_{ref} from the steering angle instruction integrating unit 44b.

The steering control apparatus 6 controls the steering angle δ of the host vehicle VH by controlling the steering apparatus (not shown) of the host vehicle VH on the basis of the steering angle instruction δ_{ref}.

When the information obtaining unit 41 obtains distance information indicating the inter-vehicle distance d between the host vehicle VH and the side vehicle VS and relative speed information indicating the relative speed vᵣₑₗ of the side vehicle VS from the second vehicle detection sensor 5, each of the speed plan creating unit 42a, the acceleration instruction control unit 43a, and the acceleration instruction integrating unit 44a operates in the same manner as in the first embodiment, using the distance information, the relative speed information, and host vehicle speed information.

As a result, the acceleration instruction integrating unit 44a generates an acceleration instruction a_{ref} for the host vehicle VH to follow the side vehicle VS.

The acceleration instruction integrating unit 44a outputs the acceleration instruction a_{ref} to the driving and braking control apparatus 4.

When the driving and braking control apparatus 4 receives the acceleration instruction a_{ref} from the acceleration instruction integrating unit 44a, the driving and braking control apparatus 4 controls each of the driving apparatus and braking apparatus of the host vehicle VH on the basis of the acceleration instruction a_{ref}.

In the above-described third embodiment, the plan creating unit 42 includes the path plan creating unit 42b that identifies, on the basis of map data indicating a map including a host vehicle's lane which is a lane in which the host vehicle is traveling, and a lane to which the host vehicle makes a lane change, a path for the host vehicle to reach the lane to which the host vehicle makes a lane change from the host vehicle's lane, creates a path plan indicating changes over time of the travel location of the host vehicle on the path, and creates, using the path plan, a steering angle plan indicating changes over time of the steering angle of the host vehicle for the host vehicle to travel on the path. In addition, the vehicle control unit 43 includes the steering angle instruction control unit 43b that calculates, using the path plan created by the path plan creating unit 42b, a steering angle control signal for controlling the steering angle of the host vehicle. Furthermore, the vehicle driving assistance apparatus 3 shown in FIG. 13 is configured in such a manner that the instruction integrating unit 44 includes the steering angle instruction integrating unit 44b that generates a steering angle instruction which is to be provided to the steering control apparatus 6 of the host vehicle, using the steering angle control signal calculated by the steering angle instruction control unit 43b and the steering angle plan created by the path plan creating unit 42b. Thus, as with the vehicle driving assistance apparatus 3 shown in FIG. 2, the vehicle driving assistance apparatus 3 shown in FIG. 13 can prevent each of occurrence of a situation in which the host vehicle gets too close to the preceding vehicle and occurrence of a situation of fluctuations in the speed of the host vehicle, during a period during which the host vehicle is following the preceding vehicle. In addition, the vehicle driving assistance apparatus 3 shown in FIG. 13 can prevent each of occurrence of a situation of a delay in following a desired lane change path and occurrence of fluctuations in steering angle.

### Fourth Embodiment

In a fourth embodiment, a vehicle driving assistance apparatus 3 including a vehicle control unit 45 instead of the vehicle control unit 43 shown in FIG. 13 will be described.

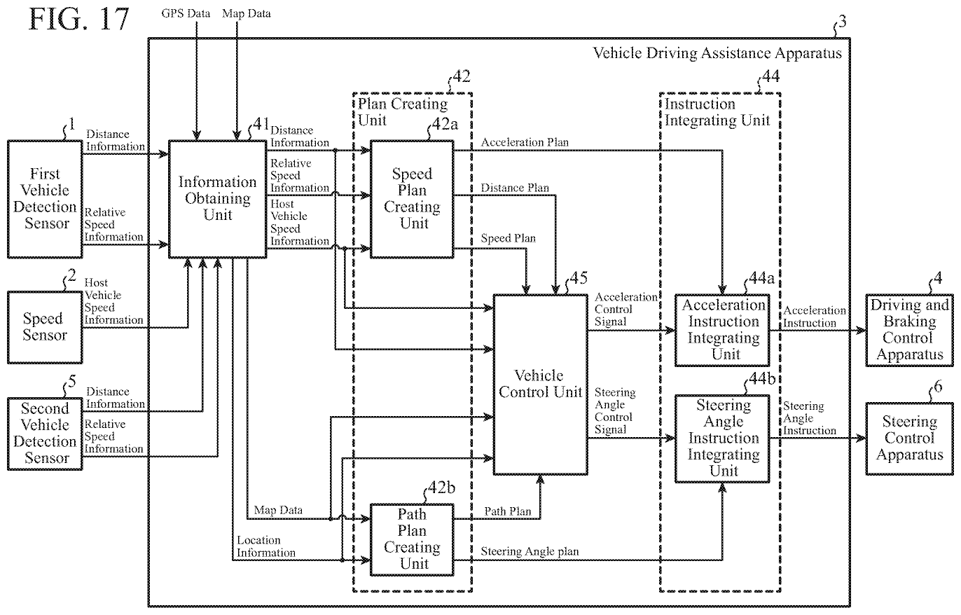

FIG. 17 is a configuration diagram showing a vehicle control apparatus including the vehicle driving assistance apparatus 3 according to the fourth embodiment. In FIG. 17, the same reference signs as those of FIG. 13 indicate the same or corresponding portions, and thus, description thereof is omitted.

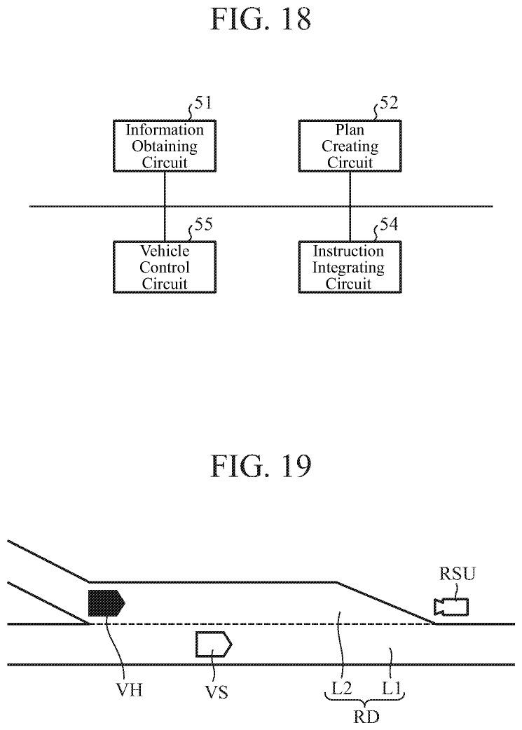

FIG. 18 is a hardware configuration diagram showing hardware of the vehicle driving assistance apparatus 3 according to the fourth embodiment. In FIG. 18, the same reference signs as those of FIG. 14 indicate the same or corresponding portions, and thus, description thereof is omitted.

The vehicle control unit 45 is implemented by, for example, a vehicle control circuit 55 shown in FIG. 18.

As with the vehicle control unit 43 shown in FIG. 13, the vehicle control unit 45 not only calculates an acceleration control signal a_{ctrl}, but also calculates a steering angle control signal δ_{ctrl}.

Unlike the vehicle control unit 43 shown in FIG. 13, the vehicle control unit 45 determines a predicted travel location which is a predicted value of the travel location of the host vehicle VH, using a dynamic vehicle model indicating behavior of the host vehicle VH.

The vehicle control unit 45 evaluates a deviation between a path plan rₚₗₐₙ and the predicted travel location, and calculates a steering angle control signal δ_{ctrl} on the basis of an evaluation value of the deviation.

In FIG. 17, it is assumed that each of the information obtaining unit 41, the plan creating unit 42, the vehicle control unit 45, and the instruction integrating unit 44 which are the components of the vehicle driving assistance apparatus 3 is implemented by dedicated hardware such as that shown in FIG. 18. Namely, it is assumed that the vehicle driving assistance apparatus 3 is implemented by the information obtaining circuit 51, the plan creating circuit 52, the vehicle control circuit 55, and the instruction integrating circuit 54.

Each of the information obtaining circuit 51, the plan creating circuit 52, the vehicle control circuit 55, and the instruction integrating circuit 54 corresponds, for example, to a single circuit, a combined circuit, a programmed processor, a parallel programmed processor, an ASIC, an FPGA, or a combination thereof.

The components of the vehicle driving assistance apparatus 3 are not limited to being implemented by dedicated hardware, and the vehicle driving assistance apparatus 3 may be implemented by software, firmware, or a combination of software and firmware.

When the vehicle driving assistance apparatus 3 is implemented by software, firmware, or the like, a program for causing a computer to perform processing procedures performed in the information obtaining unit 41, the plan creating unit 42, the vehicle control unit 45, and the instruction integrating unit 44 is stored in the memory 31 shown in FIG. 4. Then, the processor 32 shown in FIG. 4 executes the program stored in the memory 31.

In addition, FIG. 18 shows an example in which each of the components of the vehicle driving assistance apparatus 3 is implemented by dedicated hardware, and FIG. 4 shows an example in which the vehicle driving assistance apparatus 3 is implemented by software, firmware, or the like. However, they are merely examples, and some of the components of the vehicle driving assistance apparatus 3 may be implemented by dedicated hardware and the other components may be implemented by software, firmware, or the like.

Next, operations of the vehicle control apparatus shown in FIG. 17 will be described. All components other than the vehicle control unit 45 are the same as those of the vehicle control apparatus shown in FIG. 13. Hence, here, only the operations of the vehicle control unit 45 will be described.

The dynamic vehicle model indicating behavior of the host vehicle VH predicts behavior of the host vehicle VH for a period of time from a current time t(0) to the future ahead by time Th at intervals of a constant period Tₚₑᵣ.

The vehicle control unit 45 solves, every constant period, an optimization problem that determines a control input u that minimizes an evaluation function J that evaluates a deviation between a path plan rₚₗₐₙ and a predicted travel location, and then the vehicle control unit 45 calculates each solution as a steering angle control signal δ_{ctrl}. Note that each solution includes an acceleration control signal a_{ctrl} in addition to the steering angle control signal δ_{ctrl}.

A process of calculating the steering angle control signal δ_{ctrl} by the vehicle control unit 45 will be specifically described below.

The following expression (37) shows determination of a control input u that minimizes the evaluation function J.

minᵤJ (37)

\dot{x}=ƒ(x,u) (38)

x₀=x(0) (39)

The vehicle control unit 45 sets the vehicle state quantity x as shown in the following expression (40) and sets the control input u as shown in the following expression (41).

x=[d,v,a,X_{c},Y_{c}θ,β,γ,δ]^{T} (40)

u=[a_{ctrl},δ_{ctrl}]^{T} (41)

In expressions (40) and (41), d is the inter-vehicle distance between the host vehicle VH and the side vehicle VS, v is the speed of the host vehicle VH, and a is the acceleration of the host vehicle VH.

X_{c} is the longitudinal location of the center of gravity of the host vehicle VH, Y_{c} is the transverse location of the center of gravity of the host vehicle VH, and θ is the azimuth angle of the center of gravity of the host vehicle VH.

β is the side-slip angle of the host vehicle VH, γ is the yaw rate of the host vehicle VH, and δ is the steering angle of the host vehicle VH.

In addition, a_{ctrl} is the acceleration control signal and β_{ctrl} is the steering angle control signal.

The dynamic vehicle model used by the vehicle control unit 45 is represented as shown in the following expression (42).

$$\dot{x} = f ( x , u ) = [ \begin{matrix}{v}_{lead} - v \\ a \\ \frac{1}{{T}_{a}} ( {a}_{plan} + {a}_{ctrl} - a ) \\ v cos ( θ + β ) \\ v sin ( θ + β ) \\ γ \\ - γ + \frac{2}{Mv} ( {Y}_{f} + {Y}_{r} ) \\ \frac{2}{I} ( {l}_{f} {Y}_{f} - {l}_{r} {Y}_{r} ) \\ \frac{1}{{T}_{δ}} ( {δ}_{plan} + {δ}_{ctrl} - δ )\end{matrix} ] \qquad ( 42 )$$

In expression (42), Ta is the response delay of the driving and braking control apparatus 4 with respect to the acceleration instruction a_{ref}. T_{δ} is the response delay of the steering control apparatus 6 with respect to the steering angle instruction δ_{ref}.

I is the yaw moment of inertia of the host vehicle VH, Y_{f} is the cornering force of the front wheels of the host vehicle VH, and Yᵣ is the cornering force of the rear wheels of the host vehicle VH.

The cornering forces Y_{f} and Yᵣ are approximated by the following expressions (43) and (44), respectively.

$${Y}_{f} = - {K}_{f} ( β + \frac{{l}_{f}}{ν} γ - δ ) \qquad ( 43 )$$

$${Y}_{r} = - {K}_{r} ( β - \frac{{l}_{r}}{v} γ ) \qquad ( 44 )$$

The evaluation function J used by the vehicle control unit 45 is represented as shown in the following expression (45).

$$J = {( {h}_{N} ( {x}_{N} ) - {r}_{N} )}^{T} {W}_{N} ( {h}_{N} ( {x}_{N} ) - {r}_{N} ) + {\sum }_{k = 0 }^{N - 1} {( h ( {x}_{k} , {u}_{k} ) - {r}_{k} )}^{T} W ( h ( {x}_{k} , {u}_{k} ) - {r}_{k} ) \qquad ( 45 )$$

In expression (45), xₖ is the predicted value of the vehicle state quantity at a predicted point k (k=0, N), and uₖ is the control input at a predicted point k (k=0, . . . , N−1).

h is the vector-valued function for evaluation items. h_{N} is the vector-valued function for the evaluation items at the predicted point N, and rₖ is the target value at the predicted point k (k=0, . . . , N). Each of W and W_{N} is a weighting matrix and is a diagonal matrix in which a weight for each evaluation item is included in a diagonal element.

The vehicle control unit 45 sets the vector-valued function h for evaluation items as shown in the following expression (46), and sets the vector-valued function h_{N} for the evaluation items as shown in the following expression (47).

h=[dₖ,vₖ,eₖ,a_{k,ctrl},δ_{k,ctrl}]^{T} (46)

h_{N}=[d_{N},v_{N},e_{N}]^{T} (47)

In expression (46), dₖ is the predicted inter-vehicle distance which is a predicted value of the inter-vehicle distance at the predicted point k (k=0, . . . , N), vₖ is the predicted speed which is a predicted value of the speed of the host vehicle VH at the predicted point k (k=0, N), and eₖ is the path following error at the predicted point k (k=0, N). The path following error is an error in predicted path with respect to the path plan rₚₗₐₙ.

The vehicle control unit 45 sets each of a target value rₖ shown in the following expression (48) and a target value r_{N} shown in the following expression (49) so that each of the predicted inter-vehicle distance dₖ, the predicted speed vₖ, and the path following error eₖ decreases.

rₖ=[d_{plan,k},v_{plank,k},0,0,0]^{T} (48)

r_{N}=[d_{plan,N},v_{plank,N},0]^{T} (49)

The vehicle control unit 45 evaluates the path following error eₖ using the evaluation function J shown in expression (45).

The vehicle control unit 45 solves, every constant period, an optimization problem that determines a control input u at which an evaluation value of the path following error eₖ is minimized, and calculates each solution as a steering angle control signal δ_{ctrl}. A process itself of solving an optimization problem is a publicly known technique and thus a detailed description thereof is omitted.

The steering angle instruction integrating unit 44b generates, as shown in expression (36), a steering angle instruction δ_{ref} which is to be provided to the steering control apparatus 6, by integrating the steering angle plan δₚₗₐₙ and the steering angle control signal δ_{ctrl}.

In addition, the vehicle control unit 45 evaluates each of a deviation between the predicted inter-vehicle distance dₖ and the target value rₖ and a deviation between the predicted speed vₖ and the target value rₖ, using the evaluation function J shown in expression (45).

The vehicle control unit 45 solves, every constant period, an optimization problem that determines a control input u at which an evaluation value of the deviations is minimized, and calculates each solution as an acceleration control signal δ_{ctrl}.

The acceleration instruction integrating unit 44a generates, as shown in expression (10), an acceleration instruction a_{ref} which is to be provided to the driving and braking control apparatus 4 of the host vehicle VH, by integrating the acceleration control signal a_{ctrl} and the acceleration plan aₚₗₐₙ.

As with the vehicle driving assistance apparatus 3 shown in FIG. 13, the vehicle driving assistance apparatus 3 shown in FIG. 17 can also prevent each of occurrence of a situation in which the host vehicle gets too close to the preceding vehicle and occurrence of a situation of fluctuations in the speed of the host vehicle, during a period during which the host vehicle is following the preceding vehicle. In addition, the vehicle driving assistance apparatus 3 shown in FIG. 17 can prevent each of occurrence of a situation of a delay in following a desired lane change path and occurrence of fluctuations in steering angle.

### Fifth Embodiment

In a fifth embodiment, a vehicle driving assistance apparatus 3 will be described in which each of the information obtaining unit 41 and the plan creating unit 42 is provided in a roadside apparatus RSU, and each of the vehicle control unit 45 and the instruction integrating unit 44 is provided in the host vehicle VH.

FIG. 19 is an explanatory diagram showing the host vehicle VH, the side vehicle VS, and the roadside apparatus RSU.

The roadside apparatus RSU is installed on a roadside of a lane in which the host vehicle VH is traveling.

The roadside apparatus RSU includes a vehicle detection sensor corresponding to each of the first vehicle detection sensor 1 and the second vehicle detection sensor 5.

The roadside apparatus RSU detects each of an inter-vehicle distance d between the host vehicle VH and the preceding vehicle VL and relative speed vᵣₑₗ of the preceding vehicle VL, using the vehicle detection sensor.

In addition, the roadside apparatus RSU detects each of an inter-vehicle distance d between the host vehicle VH and the side vehicle VS and relative speed vᵣₑₗ of the side vehicle VS, using the vehicle detection sensor.

The vehicle detection sensor included in the roadside apparatus RSU may be able to detect even a side vehicle VS that is present in a blind spot of the second vehicle detection sensor 5.

In addition, the roadside apparatus RSU detects speed v of the host vehicle VH using the vehicle detection sensor.

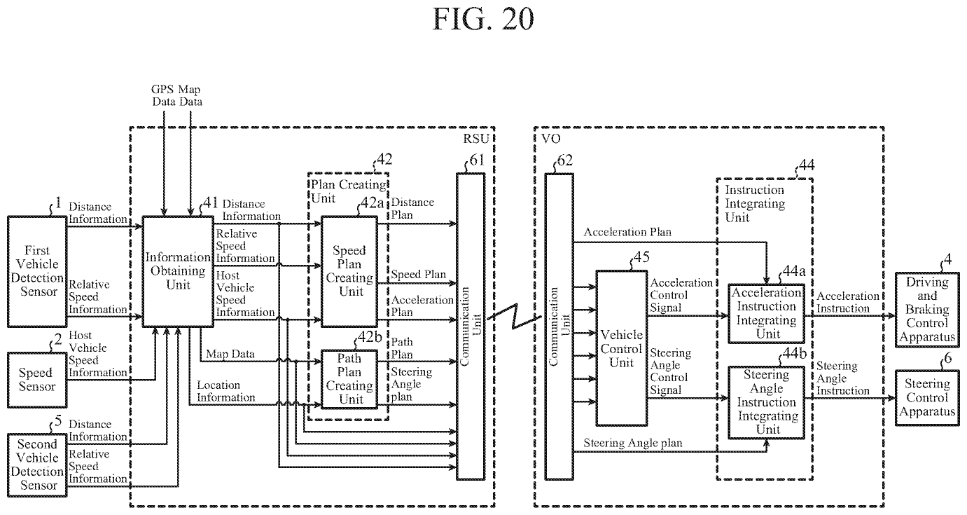

FIG. 20 is a configuration diagram showing a vehicle control apparatus including the vehicle driving assistance apparatus 3 according to the fifth embodiment. In FIG. 20, the same reference signs as those of FIG. 17 indicate the same or corresponding portions, and thus, description thereof is omitted.

Each of the information obtaining unit 41 and the plan creating unit 42 is provided in the roadside apparatus RSU.

Each of the vehicle control unit 45 and the instruction integrating unit 44 is provided in the host vehicle VH.

In the vehicle driving assistance apparatus 3 shown in FIG. 20, the vehicle control unit 45 is provided in the host vehicle VH. However, this is merely an example, and the vehicle control unit 43 shown in FIG. 13 may be provided in the host vehicle VH.

In addition, each of the information obtaining unit 11 and the plan creating unit 12 may be provided in the roadside apparatus RSU, and the vehicle control unit 13 or the vehicle control unit 15 and the instruction integrating unit 14 may be provided in the host vehicle VH.

A communication unit 61 is provided in the roadside apparatus RSU.

A communication unit 62 is provided in the host vehicle VH and performs wireless communication with the communication unit 61.

The roadside apparatus RSU is wirelessly connected to the host vehicle VH through the communication unit 61 and the communication unit 62.

Thus, the communication unit 61 transmits each of distance information, host vehicle speed information, map data, location information, a distance plan dₚₗₐₙ, a speed plan vₚₗₐₙ, an acceleration plan aₚₗₐₙ, a path plan rₚₗₐₙ, and a steering angle plan δₚₗₐₙ to the communication unit 62.

The communication unit 62 receives each of the distance information, host vehicle speed information, map data, location information, distance plan dₚₗₐₙ, speed plan vₚₗₐₙ, acceleration plan aₚₗₐₙ, path plan rₚₗₐₙ, and steering angle plan δₚₗₐₙ transmitted from the communication unit 61.

The communication unit 62 outputs each of the distance information, the host vehicle speed information, the map data, the location information, the distance plan dₚₗₐₙ, the speed plan vₚₗₐₙ, and the path plan rₚₗₐₙ to the vehicle control unit 45.

In addition, the communication unit 62 outputs each of the acceleration plan aₚₗₐₙ and the steering angle plan δₚₗₐₙ to the instruction integrating unit 44.

The vehicle driving assistance apparatus 3 shown in FIG. 20 is the same as the vehicle driving assistance apparatus 3 shown in FIG. 17 except that the roadside apparatus RSU is wirelessly connected to the host vehicle VH through the communication unit 61 and the communication unit 62.

Note that in the present disclosure, a free combination of the embodiments, modifications to any component of each of the embodiments, or omissions of any component in each of the embodiments are possible.

### REFERENCE SIGNS LIST

1: first vehicle detection sensor, 2: speed sensor, 3: vehicle driving assistance apparatus, 4: driving and braking control apparatus, 5: second vehicle detection sensor, 6: steering control apparatus, 11: information obtaining unit, 12: plan creating unit, 13, 15: vehicle control unit, 14: instruction integrating unit, 21: information obtaining circuit, 22: plan creating circuit, 23, 25: vehicle control circuit, 24: instruction integrating circuit, 31: memory, 32: processor, 41: information obtaining unit, 42: plan creating unit, 42a: speed plan creating unit, 42b: path plan creating unit, 43, 45: vehicle control unit, 43a: acceleration instruction control unit, 43b: steering angle instruction control unit, 44: instruction integrating unit, 44a: acceleration instruction integrating unit, 44b: steering angle instruction integrating unit, 51: information obtaining circuit, 52: plan creating circuit, 53, 55: vehicle control circuit, 54: instruction integrating circuit, 61, 62: communication unit

1. A vehicle driving assistance apparatus comprising:
information obtaining circuitry to obtain, from a first vehicle detection sensor to detect a preceding vehicle that is a vehicle traveling ahead of a host vehicle, distance information indicating an inter-vehicle distance between the host vehicle and the preceding vehicle and relative speed information indicating relative speed of the preceding vehicle with respect to the host vehicle, and obtain host vehicle speed information indicating speed of the host vehicle from a speed sensor;
plan creating circuitry to calculate a target inter-vehicle distance from the relative speed information and the host vehicle speed information, and create, using the inter-vehicle distance indicated by the distance information and the target inter-vehicle distance, a distance plan indicating changes over time of the inter-vehicle distance, a speed plan indicating changes over time of the speed of the host vehicle, and an acceleration plan indicating changes over time of acceleration of the host vehicle, for a period during which the host vehicle is following the preceding vehicle, the target inter-vehicle distance being a target value of the inter-vehicle distance between the host vehicle and the preceding vehicle;
vehicle control circuitry to calculate an acceleration control signal for controlling the acceleration of the host vehicle, using the distance information, the distance plan, the host vehicle speed information, and the speed plan; and
instruction integrating circuitry to generate an acceleration instruction using the acceleration control signal calculated by the vehicle control circuitry and the acceleration plan, the acceleration instruction being to be provided to a driving and braking control apparatus of the host vehicle.

2. The vehicle driving assistance apparatus according to claim 1, wherein the vehicle control circuitry determines a predicted inter-vehicle distance and predicted speed using a dynamic vehicle model indicating behavior of the host vehicle, evaluates a deviation between the distance plan and the predicted inter-vehicle distance and a deviation between the speed plan and the predicted speed, and calculates the acceleration control signal on a basis of an evaluation value of the deviations, the predicted inter-vehicle distance being a predicted value of the inter-vehicle distance between the host vehicle and the preceding vehicle, the predicted speed being a predicted value of the speed of the host vehicle.

3. The vehicle driving assistance apparatus according to claim 1, wherein
the plan creating circuitry identifies, on a basis of map data indicating a map including a host vehicle's lane and a lane to which the host vehicle makes a lane change, a path for the host vehicle to reach the lane to which the host vehicle makes a lane change from the host vehicle's lane, creates a path plan indicating changes over time of a travel location of the host vehicle on the path, and creates, using the path plan, a steering angle plan indicating changes over time of a steering angle of the host vehicle for the host vehicle to travel on the path, the host vehicle's lane being a lane in which the host vehicle is traveling,
the vehicle control circuitry calculates, using the path plan created by the plan creating circuitry, a steering angle control signal for controlling the steering angle of the host vehicle, and
the instruction integrating circuitry generates a steering angle instruction using the steering angle control signal calculated by the vehicle control circuitry and the steering angle plan created by the plan creating circuitry, the steering angle instruction being to be provided to a steering control apparatus of the host vehicle.

4. The vehicle driving assistance apparatus according to claim 3, wherein
the information obtaining circuitry obtains, from a second vehicle detection sensor to detect a side vehicle, information indicating an inter-vehicle distance between the host vehicle and the side vehicle, as the distance information, and obtains information indicating relative speed of the side vehicle with respect to the host vehicle, as the relative speed information, the side vehicle being a vehicle traveling in the lane to which the host vehicle makes a lane change, and
the plan creating circuitry calculates a target inter-vehicle distance from the relative speed information and the host vehicle speed information, the target inter-vehicle distance being a target value of the inter-vehicle distance between the host vehicle and the side vehicle.

5. The vehicle driving assistance apparatus according to claim 3, wherein the vehicle control circuitry determines a predicted travel location using a dynamic vehicle model indicating behavior of the host vehicle, evaluates a deviation between the path plan and the predicted travel location, and calculates the steering angle control signal on a basis of an evaluation value of the deviation, the predicted travel location being a predicted value of the travel location of the host vehicle.

6. The vehicle driving assistance apparatus according to claim 1, wherein
each of the information obtaining circuitry and the plan creating circuitry is provided in a roadside apparatus installed on a roadside of a lane in which the host vehicle is traveling,
each of the vehicle control circuitry and the instruction integrating circuitry is provided in the host vehicle, and
the roadside apparatus and the host vehicle are wirelessly connected to each other.

7. A vehicle driving assistance method comprising:
obtaining, from a first vehicle detection sensor to detect a preceding vehicle that is a vehicle traveling ahead of a host vehicle, distance information indicating an inter-vehicle distance between the host vehicle and the preceding vehicle and relative speed information indicating relative speed of the preceding vehicle with respect to the host vehicle, and obtaining host vehicle speed information indicating speed of the host vehicle from a speed sensor;
calculating a target inter-vehicle distance from the relative speed information and the host vehicle speed information, and creating, using the inter-vehicle distance indicated by the distance information and the target inter-vehicle distance, a distance plan indicating changes over time of the inter-vehicle distance, a speed plan indicating changes over time of the speed of the host vehicle, and an acceleration plan indicating changes over time of acceleration of the host vehicle, for a period during which the host vehicle is following the preceding vehicle, the target inter-vehicle distance being a target value of the inter-vehicle distance between the host vehicle and the preceding vehicle;
calculating an acceleration control signal for controlling the acceleration of the host vehicle, using the distance information, the distance plan, the host vehicle speed information, and the speed plan; and
generating an acceleration instruction using the acceleration control signal calculated and the acceleration plan, the acceleration instruction being to be provided to a driving and braking control apparatus of the host vehicle.

8. A vehicle control apparatus comprising:
a first vehicle detection sensor to detect a preceding vehicle that is a vehicle traveling ahead of a host vehicle, and output distance information indicating an inter-vehicle distance between the host vehicle and the preceding vehicle and relative speed information indicating relative speed of the preceding vehicle with respect to the host vehicle;
a speed sensor to output host vehicle speed information indicating speed of the host vehicle;
information obtaining circuitry to obtain each of the distance information and the relative speed information from the first vehicle detection sensor, and obtain the host vehicle speed information from the speed sensor;
plan creating circuitry to calculate a target inter-vehicle distance from the relative speed information and the host vehicle speed information, and create, using the inter-vehicle distance indicated by the distance information and the target inter-vehicle distance, a distance plan indicating changes over time of the inter-vehicle distance, a speed plan indicating changes over time of the speed of the host vehicle, and an acceleration plan indicating changes over time of acceleration of the host vehicle, for a period during which the host vehicle is following the preceding vehicle, the target inter-vehicle distance being a target value of the inter-vehicle distance between the host vehicle and the preceding vehicle;
vehicle control circuitry to calculate an acceleration control signal for controlling the acceleration of the host vehicle, using the distance information, the distance plan, the host vehicle speed information, and the speed plan; and
instruction integrating circuitry to generate an acceleration instruction using the acceleration control signal calculated by the vehicle control circuitry and the acceleration plan, the acceleration instruction being to be provided to a driving and braking control apparatus of the host vehicle.
